(19) United States
(12) Patent Application Publication
(10) Pub. No.: US 2026/0106511 A1
(43) Pub. Date: Apr. 16, 2026

(54) MOTOR DRIVE UNIT COOLING SYSTEM

(71) Applicant: ITT Manufacturing Enterprises LLC, Wilmington, DE (US)

(72) Inventors: Dean P. Williams, Moravia, NY (US); Daniel Jason Kernan, Liverpool, NY (US)

(21) Appl. No.: 19/353,297

(22) Filed: Oct. 8, 2025

Related U.S. Application Data
(60) Provisional application No. 63/706,392, filed on Oct. 11, 2024.
(60) Provisional application No. 63/706,381, filed on Oct. 11, 2024.

(51) Int. Cl. H02K 5/20; H02K 5/10; H02K 9/06; H02K 9/193; H02K 11/33

(52) U.S. Cl. CPC H02K 5/203; H02K 5/10; H02K 9/06; H02K 9/193; H02K 11/33

(57) ABSTRACT

A motor assembly for driving a pump or rotary device features a power plane with a circular geometry to be mounted inside a space envelope having a similar circular geometry formed on an end-plate between an inner hub portion and a peripheral portion that extends circumferentially around the space envelope of the end-plate. The power plane is a multi-layer circuit board or assembly having: a power layer with higher temperature power modules for providing power to a motor, a control layer with lower temperature control electronics modules for controlling the power provided to the motor, and a thermal barrier and printed circuit board layer between the power layer and the control layer that provides electrical connection paths between the power modules of the power plane and the control electronics modules of the control layer, and also provides insulation between the power layer and the control layer.

### INCORPORATION BY REFERENCE TO ANY PRIORITY APPLICATIONS

This application claims priority to U.S. Provisional Application No. 63/706,381, filed on Oct. 11, 2024, the disclosure of which is hereby incorporated by reference herein for all purposes, and this application claims priority to U.S. Provisional Application No. 63/706,392, filed on Oct. 11, 2024, the disclosure of which is hereby incorporated by reference herein for all purposes. Further, this application incorporates by reference for all purposes herein: U.S. application Ser. No. 18/512,748, filed on Nov. 17, 2023; U.S. application Ser. No. 18/421,247, filed on Jan. 24, 2024; and International Application No. PCT/US2024/012444, filed on Jan. 22, 2024. Any and all applications for which a foreign or domestic priority claim is identified in the Application Data Sheet as filed with the present application are hereby incorporated by reference under 37 CFR 1.57.

### BACKGROUND

This application relates to variable frequency motor drives, such as those used in industrial pumps or other rotary devices. Variable frequency drive electronics can be sensitive to heat. It can be a challenge to effectively manage the temperature of the drive electronics as the number of heat generating devices in the drive electronics increases or the drive electronics are placed in proximity to relatively hot running electric motor.

### SUMMARY

The systems, methods and devices of this disclosure each have several innovative aspects, no single one of which is solely responsible for all of the desirable attributes disclosed herein. Details of one or more implementations of the subject matter described in this specification are set forth in the accompanying drawings and the description below.

Aspects of the disclosure relate to variable frequency drives capable of driving increased horsepower while maintaining a relatively small form factor and/or maintaining a safe operating temperature, such as where the variable frequency drive is an embedded motor drive integrated with and configured for mounting to an electric motor. The electric motor and integrated motor drive can be for powering a rotary device such as an industrial pump or other type of machinery.

According to certain embodiments, the electronic variable frequency drive is configured for mounting inside the same size envelope as a standard National Electrical Manufacturers Association (NEMA) or International Electrotechnical Commission (IEC) rated motor of the same power rating, thereby allowing variable speed operation of the motor and any pump or rotary device it controls.

In some aspects, the techniques described herein relate to a motor assembly including: a motor housing; an electrical motor at least partially disposed in the motor housing; a mid-plate disposed in-line with the motor housing, the mid-plate having a first mid-plate wall distal to the motor housing; an end-plate disposed in-line with the mid-plate such that the mid-plate is between the motor housing and the end-plate, the end-plate having a back wall proximal to the first mid-plate wall and a side wall that is orthogonal to the back wall of the end-plate, wherein the back wall and the side wall form a cavity; and a variable frequency drive electronics unit disposed within the cavity and configured to provide power to the electrical motor, wherein the variable frequency drive electronics unit includes a plurality of power modules distributed along an interior of the cavity and along the side wall of the end-plate.

In some aspects, the techniques described herein relate to a motor assembly, wherein the end-plate is circular in shape and the plurality of power modules are distributed evenly along the interior of the cavity and along the side wall of the end-plate.

In some aspects, the techniques described herein relate to a motor assembly, wherein the end-plate forms a nonagon.

In some aspects, the techniques described herein relate to a motor assembly, wherein a pair of power modules from the plurality of power modules is disposed along each side of the nonagon.

In some aspects, the techniques described herein relate to a motor assembly, wherein each side of the nonagon is configured to support at least a power module from the plurality of power modules and a capacitor.

In some aspects, the techniques described herein relate to a motor assembly, wherein the end-plate forms a rectangle.

In some aspects, the techniques described herein relate to a motor assembly, wherein a greater number of power modules of the plurality of power modules are distributed on a first pair of sides of the end-plate than on a second pair of sides of the end-plate.

In some aspects, the techniques described herein relate to a motor assembly, wherein the variable frequency drive electronics unit implements a matrix converter that converts a first AC signal to a second AC signal.

In some aspects, the techniques described herein relate to a motor assembly, wherein at least one of the back wall or the side wall of the end-plate is included of a conductive material.

In some aspects, the techniques described herein relate to a motor assembly, wherein a matrix converter formed from the plurality of power modules includes a multi-level matrix converter including 18 power modules.

In some aspects, the techniques described herein relate to a motor assembly, wherein the end-plate includes an opening within the back wall to permit passage of a rotor.

In some aspects, the techniques described herein relate to a motor assembly, wherein a non-drive end portion of the rotor is configured to rotate a fan causing air flow over at least a portion of the end-plate.

In some aspects, the techniques described herein relate to a motor assembly, wherein the portion of the end-plate includes heatsink fins configured to dissipate heat generated by one or more of the plurality of power modules.

In some aspects, the techniques described herein relate to a variable frequency motor drive including: a plate configured to directly or indirectly mount to an electrical motor, the plate having an end wall and a peripheral wall that is orthogonal to the end wall of the plate, wherein the end wall and the peripheral wall form a cavity; and a variable frequency drive electronics unit disposed within the cavity and configured to provide power to the electrical motor, wherein the variable frequency drive electronics unit includes a plurality of power modules distributed along the peripheral wall within the cavity of the plate.

In some aspects, the techniques described herein relate to a variable frequency motor drive, wherein the plate is circular in shape and the plurality of power modules are distributed evenly along the peripheral wall.

In some aspects, the techniques described herein relate to a variable frequency motor drive, wherein the peripheral wall of the plate forms a nine-sided polygon.

In some aspects, the techniques described herein relate to a variable frequency motor drive, wherein a pair of power modules from the plurality of power modules is disposed along each side of the nine-sided polygon.

In some aspects, the techniques described herein relate to a variable frequency motor drive, wherein each side of the nine-sided polygon is configured to support at least a power module from the plurality of power modules and a capacitor.

In some aspects, the techniques described herein relate to a variable frequency motor drive, wherein the peripheral wall of the plate forms a rectangle.

In some aspects, the techniques described herein relate to a variable frequency motor drive, wherein a greater number of power modules of the plurality of power modules are distributed on a longer pair of sides of the plate than on a shorter pair of sides of the plate.

In some aspects, the techniques described herein relate to a variable frequency motor drive, wherein the variable frequency drive electronics unit implements a matrix converter that converts a first AC signal to a second AC signal.

In some aspects, the techniques described herein relate to a variable frequency motor drive, wherein at least one of the end wall or the peripheral wall of the plate is included of a conductive material.

In some aspects, the techniques described herein relate to a variable frequency motor drive, wherein a matrix converter formed from the plurality of power modules includes a multi-level matrix converter including 18 power modules.

In some aspects, the techniques described herein relate to a variable frequency motor drive, wherein the plate includes an opening within the end wall to permit passage of a rotor.

In some aspects, the techniques described herein relate to a variable frequency motor drive, wherein a non-drive end portion of the rotor is configured to rotate a fan causing air flow over at least a portion of the plate.

In some aspects, the techniques described herein relate to a variable frequency motor drive, wherein the portioned is:

In some aspects, the techniques described herein relate to a motor assembly including: a motor housing; an electrical motor at least partially disposed in the motor housing; a mid-plate disposed in-line with the motor housing, the mid-plate having a first mid-plate wall distal to the motor housing; an end-plate disposed in-line with the mid-plate such that the mid-plate is between the motor housing and the end-plate, the end-plate having an interior wall and an exterior wall, wherein a gap exists between the interior wall and the exterior wall, and wherein the interior wall forms a cavity; and a variable frequency drive electronics unit disposed within the cavity and configured to provide power to the electrical motor, wherein the variable frequency drive electronics unit includes a plurality of power modules distributed along the interior wall of the cavity.

In some aspects, the techniques described herein relate to a motor assembly, further including a thermal conductor positioned at an entrance to the cavity.

In some aspects, the techniques described herein relate to a motor assembly, wherein the cavity is sealed to prevent or reduce an occurrence of dust within the cavity.

In some aspects, the techniques described herein relate to a motor assembly, wherein the exterior wall of the end-plate includes an ingress hole and an egress hole, and wherein the ingress hole and the egress hole do not extend through the interior wall of the end-plate.

In some aspects, the techniques described herein relate to a motor assembly, further including a fan configured to cause air to flow through the ingress hole towards the egress hole.

In some aspects, the techniques described herein relate to a motor assembly, wherein the ingress hole is located on a back wall of the end-plate, and wherein the back wall faces a fan configured to cause air to flow along the back wall and into the ingress hole.

In some aspects, the techniques described herein relate to a motor assembly, wherein the egress hole is located on a peripheral wall of the end-plate, and wherein an air flow generated by a fan causes air to flow into the ingress hole and out of the egress hole.

In some aspects, the techniques described herein relate to a motor assembly, further including: a pipe positioned to enter the ingress hole and to exit the egress hole; and a coolant system configured to distribute a liquid coolant through the pipe.

In some aspects, the techniques described herein relate to a motor assembly, wherein the pipe is further positioned to contact a portion of the interior wall that is in contact with the plurality of power modules.

In some aspects, the techniques described herein relate to a motor assembly, wherein the pipe includes an ingress pipe and an egress pipe, wherein the egress pipe is configured to transport the liquid coolant from the coolant system through the gap between the interior wall and the exterior wall, and wherein the ingress pipe is configured to transport the liquid coolant back towards the coolant system.

In some aspects, the techniques described herein relate to a motor assembly, wherein the coolant system includes a pump that pumps the liquid coolant through the pipe.

In some aspects, the techniques described herein relate to a motor assembly, wherein the coolant system includes a reservoir to at least temporarily store the liquid coolant.

In some aspects, the techniques described herein relate to a motor assembly, further including a fan configured to cause air to flow along the coolant system to cool the liquid coolant.

In some aspects, the techniques described herein relate to a motor assembly, wherein the end-plate further includes an opening to receive a non-drive end of a rotor, and wherein the non-drive end of the rotor is configured to rotate a fan to cause air to flow along the exterior wall of the end-plate.

In some aspects, the techniques described herein relate to a variable frequency motor drive including: a plate configured to directly or indirectly mount to an electrical motor, the plate having an interior wall and an exterior wall, wherein a gap exists between the interior wall and the exterior wall, and wherein the interior wall forms a cavity; and a variable frequency drive electronics unit disposed within the cavity and configured to provide power to the electrical motor, wherein the variable frequency drive electronics unit includes a plurality of power modules distributed along the interior wall of the cavity.

In some aspects, the techniques described herein relate to a variable frequency motor drive, further including a thermal conductor positioned at an entrance to the cavity.

In some aspects, the techniques described herein relate to a variable frequency motor drive, wherein the cavity is sealed to prevent or reduce an occurrence of contaminants within the cavity.

In some aspects, the techniques described herein relate to a variable frequency motor drive, wherein the exterior wall of the plate includes an ingress hole and an egress hole, and wherein the ingress hole and the egress hole do not extend through the interior wall of the plate.

In some aspects, the techniques described herein relate to a variable frequency motor drive, further including a fan configured to cause air to flow through the ingress hole towards the egress hole.

In some aspects, the techniques described herein relate to a variable frequency motor drive, wherein the ingress hole is located on a back wall of the plate, and wherein the back wall faces a fan configured to cause air to flow along the back wall and into the ingress hole.

In some aspects, the techniques described herein relate to a variable frequency motor drive, wherein the egress hole is located on a peripheral wall of the plate, and wherein an air flow generated by a fan causes air to flow into the ingress hole and out of the egress hole.

In some aspects, the techniques described herein relate to a variable frequency motor drive, further including: a pipe positioned to enter the ingress hole and to exit the egress hole; and a coolant system configured to distribute a liquid coolant through the pipe.

In some aspects, the techniques described herein relate to a variable frequency motor drive, wherein the pipe is further positioned to contact a portion of the interior wall that is in contact with the plurality of power modules.

In some aspects, the techniques described herein relate to a variable frequency motor drive, wherein the pipe includes an ingress pipe and an egress pipe, wherein the egress pipe is configured to transport the liquid coolant from the coolant system through the gap between the interior wall and the exterior wall, and wherein the ingress pipe is configured to transport the liquid coolant back towards the coolant system.

In some aspects, the techniques described herein relate to a variable frequency motor drive, wherein the coolant system includes a pump that pumps the liquid coolant through the pipe.

In some aspects, the techniques described herein relate to a variable frequency motor drive, wherein the coolant system includes a reservoir to at least temporarily store the liquid coolant.

In some aspects, the techniques described herein relate to a variable frequency motor drive, further including a fan configured to cause air to flow along the coolant system to cool the liquid coolant.

In some aspects, the techniques described herein relate to a variable frequency motor drive, wherein the plate further includes an opening to receive a non-drive end of a rotor, and wherein the non-drive end of the rotor is configured to rotate a fan to cause air to flow along the exterior wall of the plate.

### BRIEF DESCRIPTION OF THE DRAWINGS

Aspects and advantages of the embodiments provided herein are described with reference to the following detailed description in conjunction with the accompanying drawings. Throughout the drawings, reference numbers may be re-used to indicate correspondence between referenced elements. The drawings are provided to illustrate example embodiments described herein and are not intended to limit the scope of the disclosure. In addition, various features of different disclosed embodiments can be combined to form additional embodiments, which are part of this disclosure. Further, one or more features or structures can be removed or omitted. The drawing includes the following Figures, which are not necessarily drawn to scale.

FIG. 1 is an exploded view of one embodiment of a motor assembly for driving a pump or rotary device in accordance with certain embodiments.

FIG. 2 is a cross-sectional view of part of the motor assembly of FIG. 1 in accordance with certain embodiments.

FIG. 3 is a front view (mid-plate side) of the end-plate of the motor assembly of FIG. 1 in accordance with certain embodiments.

FIG. 4 and FIG. 5A are a back view and a front perspective view, respectively, of the end-plate of the motor assembly of FIG. 1 in accordance with certain embodiments.

FIG. 5B is an exploded perspective view of the motor, terminal box, mid-plate, and end-plate in accordance with certain embodiments.

FIG. 6 is a perspective view of the end-plate 140 of the motor assembly of FIG. 1 with the conductive cover removed in accordance with certain embodiments.

FIG. 7 is a perspective view of the multi-board power plane and the corresponding electronics in accordance with certain embodiments.

FIG. 8 is an exploded view of the end-plate and its internal components (e.g., multi-board power plane) in accordance with certain embodiments.

FIG. 9 is a cross-section view of the end-plate and its internal components (e.g., multi-board power plane) in accordance with certain embodiments.

FIG. 10A and FIG. 10B are a front cross-section views (mid-plate side) of the end-plate and the motor assembly of FIG. 1 in accordance with certain embodiments.

FIG. 11 is a front view (e.g., mid-plate side) of the power layer of the multi-board power plane in accordance with certain embodiments.

FIG. 12 is a back view (e.g., fan side) of the power layer of the multi-board power plane in accordance with certain embodiments.

FIG. 13 and FIG. 14 are front and back views, respectively, of the control layer of the multi-board power plane in accordance with certain embodiments.

FIG. 15 and FIG. 16 are front and back views, respectively, of the second control layer of the multi-board power plane in accordance with certain embodiments.

FIG. 17A and FIG. 17B are front and back views of the control PCB board and housing of the third control layer of the multi-board power plane in accordance with certain embodiments.

FIG. 18 shows front and back views of the switched-mode power supply of the multi-board power plane in accordance with certain embodiments.

FIG. 19 and FIG. 20 are a front and front-perspective view, respectively of the mid-plate of the motor assembly of FIG. 1 in accordance with certain embodiments.

FIG. 21 and FIG. 22 are a back and back-perspective view, respectively of the mid-plate of the motor assembly of FIG. 1 in accordance with certain embodiments.

FIG. 23 is a perspective view of the motor assembly of FIG. 1 in accordance with certain embodiments.

FIG. 24A, FIG. 24B, and FIG. 24C are top views of the terminal box of the motor assembly of FIG. 1 in accordance with certain embodiments.

FIG. 25A is a front view of an example of an end-plate with circumferentially distributed matrix converter circuit elements in accordance with certain embodiments.

FIG. 25B is a front perspective view of the example end-plate of FIG. 25A in accordance with certain embodiments.

FIG. 26A is a front view of an example of a nonagonal end-plate with distributed matrix converter circuit elements in accordance with certain embodiments.

FIG. 26B is a front view of an example of a rectangular end-plate with distributed matrix converter circuit elements in accordance with certain embodiments.

FIG. 27A is a side view of an example of an end-plate that is hollow to permit air from a fan to flow through the hollow end-plate in accordance with certain embodiments.

FIG. 27B is a front view of the example end-plate of FIG. 27A in accordance with certain embodiments.

FIG. 28A is a side view of an example of an end-plate that includes a liquid cooling system in accordance with certain embodiments.

FIG. 28B is a front view of the example end-plate of FIG. 28A in accordance with certain embodiments.

FIG. 29 is an example of the end-plate of FIG. 25A with terminal box connectors in accordance with certain embodiments.

FIG. 30 is an exploded view of the end-plate of FIG. 25A and certain internal components in accordance with certain embodiments.

FIG. 31 is a schematic diagram of a matrix converter according to certain embodiments.

FIG. 32 is a schematic diagram of a clamp for a matrix converter in accordance with certain embodiments.

FIG. 33 is a schematic diagram of a portion of circuitry of a matrix converter in accordance with certain embodiments.

FIG. 34A is a schematic diagram of a bidirectional switch according to certain embodiments.

FIG. 34B is a schematic diagram of a bidirectional switch according to certain embodiments.

FIG. 34C is a schematic diagram of a bidirectional switch according to certain embodiments.

FIG. 35 is a schematic diagram of a matrix converter according to certain embodiments.

FIG. 36A shows a diagram of a bi-directional switch for implementing some part of the power functionality, e.g., of the power plane, according to some embodiments, and FIG. 36B shows an example of a bi-directional switch power module for implementing some part of the power functionality, according to some embodiments.

The drawings include examples of possible implementations; and the scope is not intended to be limited to the implementations shown therein. For example, the scope is intended to include, and embodiments are envisioned using, other implementations besides, or in addition to, that shown in the drawings, which may be configured within the spirit of the disclosure in the present application as a whole.

### DETAILED DESCRIPTION

A motor assembly may drive a pump or rotary device. The motor assembly may include a motor. The motor may be at least partially housed or supported by a motor frame and may include a stator arranged therein, a rotor coupled to the motor, one or more plates that can include a bearing housing, electronics, insulation, gaskets, and thermal adjustment mechanism (e.g., heatsinks, cooling fins, fans, etc.). The motor frame may also include a terminal box that can include at least some of the electronics of the motor assembly, such as a control system, which may include a variable frequency drive, configured for controlling the operation of the motor, which in turn is used for driving the pump or other rotary device. The motor frame may be or may include a motor housing that, at least in part, houses or supports the motor.

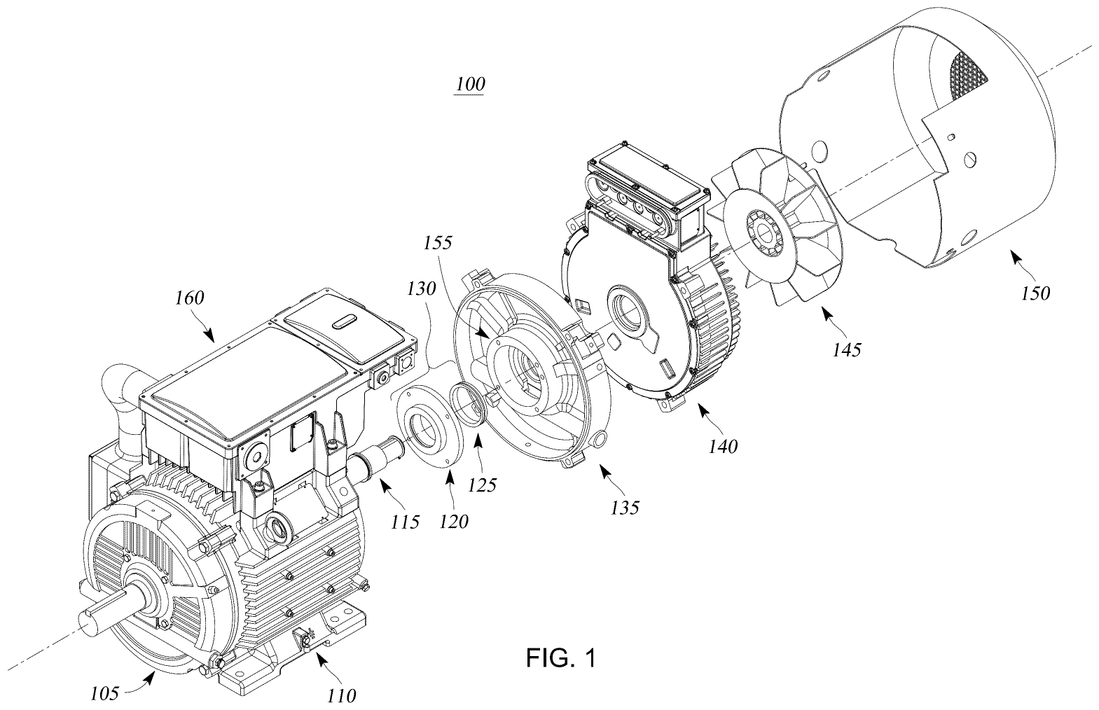

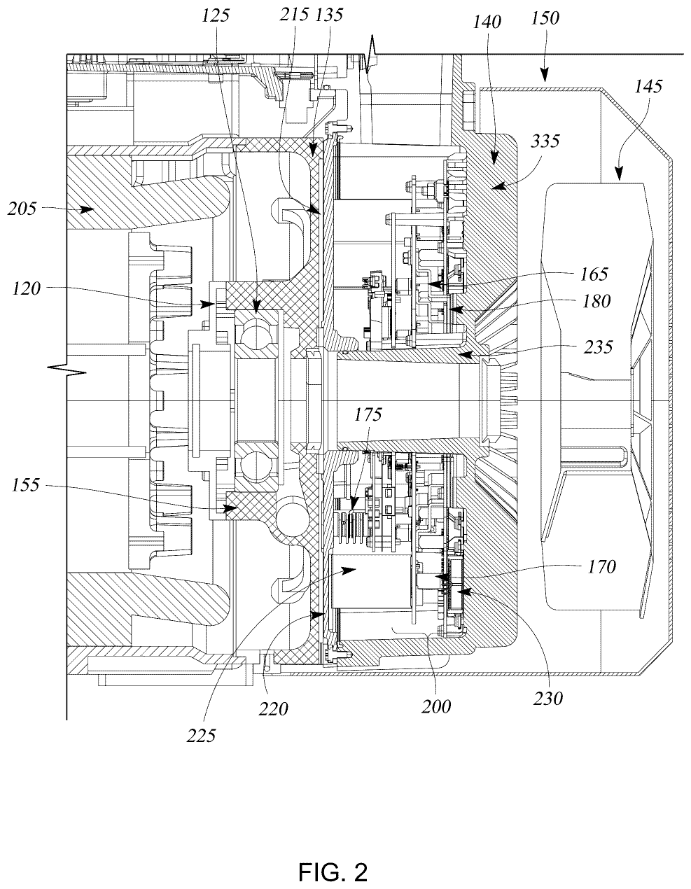

FIG. 1 is an exploded view of one embodiment of a motor assembly 100 for driving a pump or rotary device. The motor assembly 100 may be used for driving a pump, compressor, fan, and/or rotary device (not shown). The motor assembly 100 includes a motor 105. The motor 105 may include a motor frame 110 with a space envelope (e.g., cavity) that at least partially envelops a stator 205 (see FIG. 2) and a rotor 115.

A variable frequency electronics drive unit includes a mid-plate 135 and an end-plate 140. The rotor 115 of the illustrated embodiment extends through and couples to the mid-plate 135, the end-plate 140, and/or a fan 145. As shown, the variable frequency drive unit including the mid-plate 135 and the end-plate 140 can be axially mounted to the motor frame 110 in an in-line configuration, extending from the non-drive end side of the motor frame 110. In some cases, one or more of the mid-plate 135 or the end-plate 140 are be directly mounted to the motor 105. In other cases, the mid-plate 135 and/or the end-plate 140 are indirectly mounted in that there may be one or more elements between the mid-plate 135 and/or the end-plate 140 and the motor 105, such as an additional plate or a thermal layer. In some embodiments, the fan 145 is powered by the motor 105 (e.g., as in the illustrated embodiment via the rotor 115).

The mid-plate 135 may have a bearing housing flange portion 155. The motor 105 can includes a motor bearing assembly 130 that includes a bearing assembly 125, a front grease retainer 120, and/or a rear grease retainer (not shown). The end-plate 140 may include a multi-board power plane 200 (see FIG. 2). In other embodiments, the end-plate 140 may include a power plane or power layer 800 of any of the embodiments described herein.

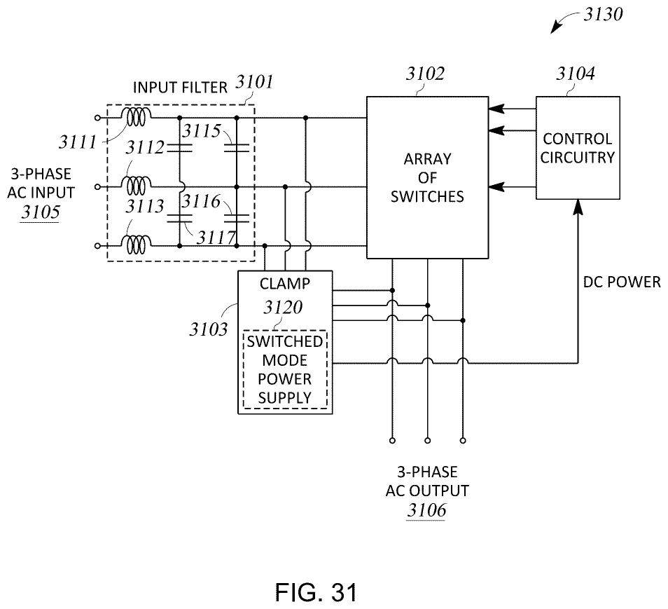

The motor assembly 100 may also, or alternatively, include a shroud 150 and a terminal box 160. In some embodiments, the terminal box 160 is attached to the top of the motor frame 110 and may include electronics, e.g., electronics of a variable frequency drive including capacitors, inductors, and/or power modules. The terminal box 160 will be described in more detail below. In some embodiments, the electronic components of the variable frequency drive (VFD) and/or matrix converter may be split between the terminal box 160 and the end-plate 140. As one example, the matrix converter can include some or all of the components of the matrix converter 3130 of FIG. 31, where the inductors 3111, 3112, 3113 are included in the terminal box 160, and some or all of the remaining components of the matrix converter 3130, such as the array of switches 3102 and or capacitors 3115, 3116, 3117, are included in the end-plate 140. As described herein, the electronic components of the variable frequency drive may include one or more circuit boards, power modules, and power control components.

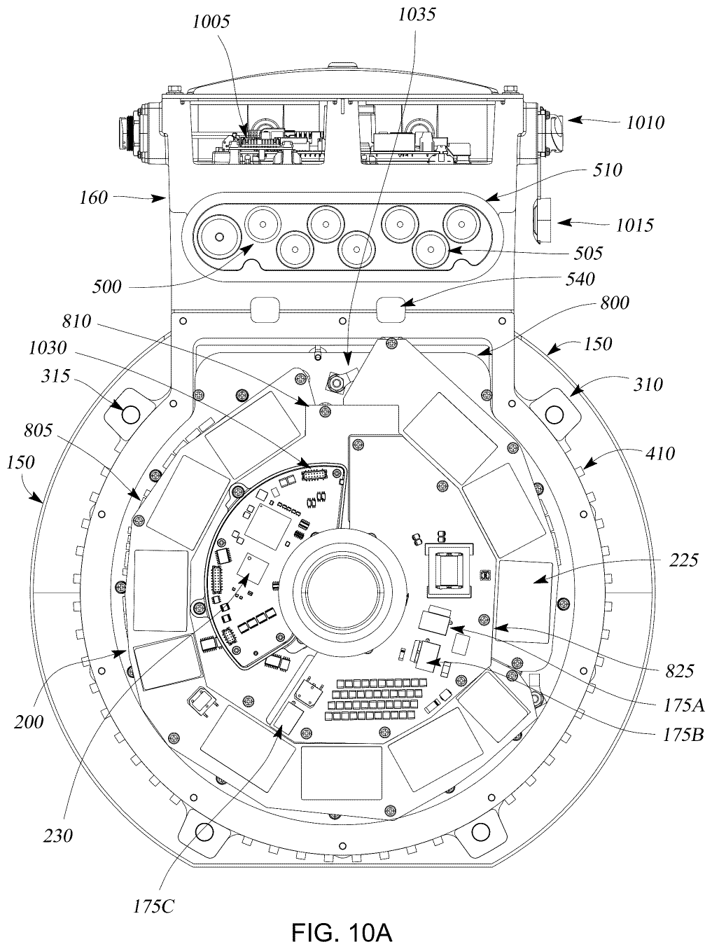

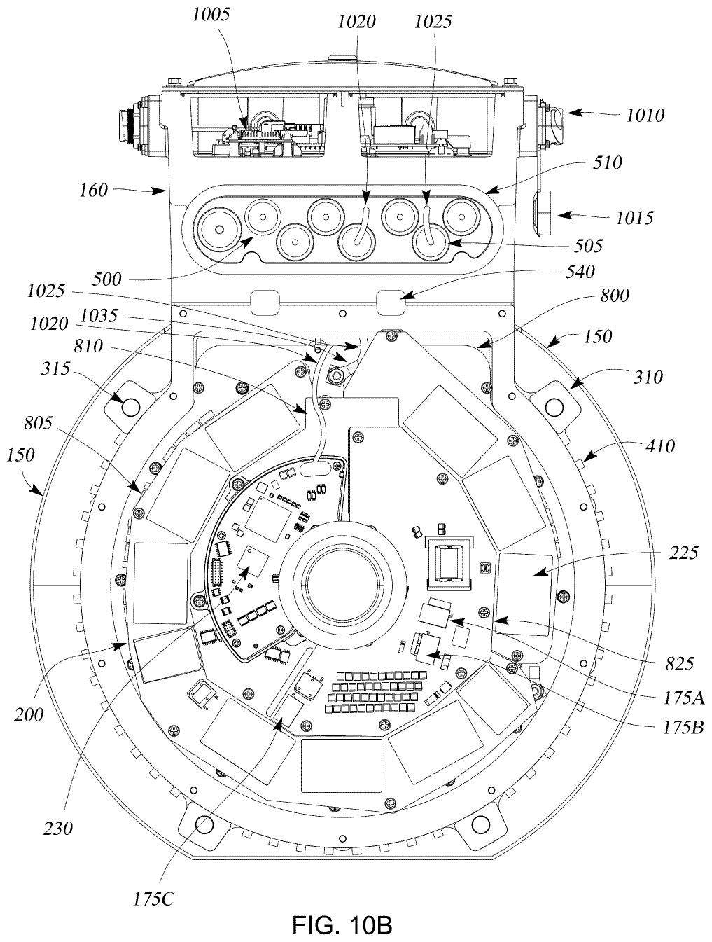

FIG. 2 is a cross-sectional view of part of the motor assembly 100 of FIG. 1. As described above, the end-plate 140 may have a multi-board power plane 200. For example, the multi-board power plane 200 may include two, three, four, five, six, or more than six separate printed circuit boards. In some embodiments, the multi-board power plane 200 may have one or more power layers or segments and one or more control layers or segments. Alternatively, or in addition, the multi-board power plane 200 may include the electronics of a variable frequency drive and/or a matrix converter (e.g., one or more power modules and power control components). For example, one or more of the PCB boards of the multi-board power plane 200 may include high temperature components 230 (e.g., power semi-conductors, power modules, etc.) while one or more other PCBs include low temperature (e.g., temperature sensitive) components 225 (e.g., control electronics, power quality filter capacitors, etc.). One or more of the low temperature components 225 may be coupled to a heat sink 175A, 175B, 175C (see FIG. 10A) to advantageously cool the low temperature components 225. The heat sinks 175A, 175B, 175C may have cooling fins to improve heat dissipation.

In some embodiments, the multi-board power plane 200 may include a communication board. The communication board may facilitate communication between the power layers and the control layers. However, in some embodiments, the power layers and control layers communicate to each other without using a separate communication board. For example, the power layers and control layers may be connected to each other through data connectors 170, which can be PCB-to-PCB connectors, for example, allowing components on the different layers to communicate with one another. Similarly, the power layers and control layers may be connected to a power distribution system via one or more busbars 165, 180. In some embodiments, the busbar 165 may be a double-L bar made of a conductive material (e.g., copper, gold). Additionally, or alternatively, the multi-board power plane 200 may include a busbar 180 that is toroidal-shaped or cylindrical-shaped that encircles the central column 235 of the end-plate 140. It should be noted that the multi-board power plane 200 may include one or more busbars of any other shape to connect the PCB boards and electrical components to one or more power distribution systems.

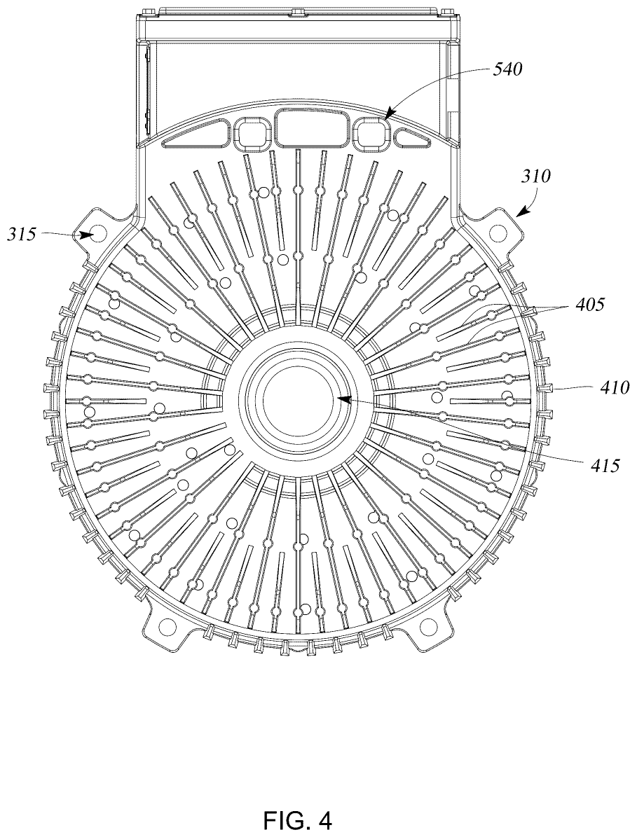

The first side of the end-plate 140 may be coupled to the second side of the mid-plate 135. The first side of the end-plate 140 may have a thermally conductive cover 220. In some embodiments, some or all of the low temperature components 225 (e.g., some of the electronic components of the variable frequency drive) are in physical contact with the conductive cover 220. Thus, the end-plate 140 may advantageously have a thermal pathway for dissipating the heat from, e.g., the low temperature components 225 to the conductive cover 220 (e.g., the conductive cover 220 acts as a heat sink). The conductive cover 220 may be made of any thermally conductive material (e.g., copper, gold), including any materials described herein. Furthermore, the high temperature components 230 may be in physical contact with the end-plate housing 335. Thus, the end-plate 140 may advantageously have a thermal pathway for dissipating the heat from the high temperature components 230 to the end-plate housing 335 and further to the radial cooling fins 405 and peripheral cooling fins 410 (FIG. 4). The end-plate housing 335 may be made of any thermally conductive material (e.g., metal, such as aluminum, steel, etc.), including any materials described herein. Thus, the end-plate 140 may efficiently dissipate the heat caused by the operation of the motor 105 and the multi-board power plane 200 away from the electronic components and to the external environment.

Furthermore, referring to FIG. 1 again, the motor assembly 100 may include a thermal insulation gap 215 between the end-plate 140 and the mid-plate 135. The thermal insulation gap 215 may be an insulative air gap. Advantageously, the insulative air gap 215 may be made narrow to the reduce the size of the motor assembly 100, while wide enough to allow heat to escape and reduce heat transfer between the mid-plate 135 and the end-plate 140. For example, the insulative air gap may have a thickness of 1 mm, 2, mm, 3.5 mm, 5 mm, 10 mm, more than 10 mm, or any thickness in-between. Alternatively, in higher temperature applications, the insulative air gap 215 may be 1 cm, 2 cm, 5 cm, 10 cm, more than 10 cm, or any thickness in-between. The insulative air gap 215 may inhibit (e.g., prevent or limit) the heat emitted from the motor 105 from reaching the electrical components in the end-plate 140. In some embodiments, the insulative air gap 215 may be connected to the external environment (e.g., through a vent or gap at mid-plate/end-plate coupling point) and allow at least some portion of the heat generated by the motor 105 and low temperature components 225 to be transferred to the external environment. Thus, the insulative air gap 215 may advantageously protect the electronic components in the end-plate 140 from the heat of the motor 105 while simultaneously enabling the motor 105 and the conductive cover 220 to dissipate heat. Alternatively, or in addition, the thermal insulation gap 215 may be a layer of any non-conductive material.

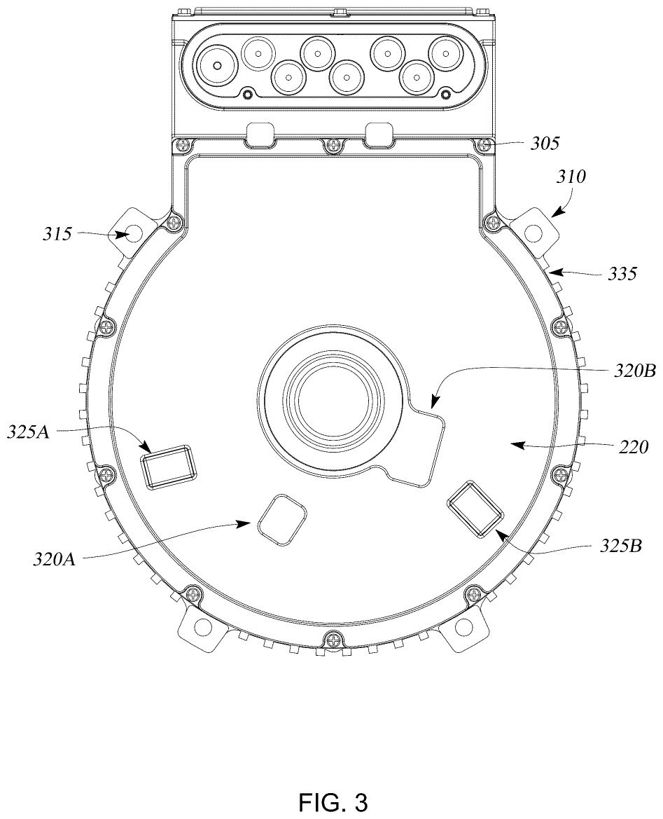

FIG. 3 is a front view (mid-plate 135 side) of the end-plate 140 of the motor assembly 100 of FIG. 19. The conductive cover 220 may be coupled to the end-plate housing 335 via one or more fasteners 305 (e.g., screws, snap-fit connectors, etc.). Alternatively, or in addition, the end-plate 140 may have one or more retaining members 310 (e.g., four) that include an aperture 315 for receiving a fastener (e.g., a dowel, screw or threaded bolt, snap-fit connector, etc.) to fasten the end-plate 140 to the mid-plate 135. The retaining members 310 may be mounting guides that advantageously help a user assemble the motor assembly 100. For example, a user may slide one or more dowels or bolts into the apertures 315 and easily push the end-plate 140 into place (e.g., in-between the mid-plate 135 and fan 145). In some embodiments, the dowels may be tapered to make it easier to insert the dowels into the aperture 315. Furthermore, the retaining members 310 may axially protrude beyond the conductive cover 220 to leave space for or set the thickness of the thermal insulation gap 215 between the end-plate 140 and mid-plate 135. However, in some embodiments, the retaining members 310 may be co-planar with the conductive cover 220.

In some alternative embodiments, the apertures 315 of the retaining member 310 receive dowels or bolts that are attached to the motor frame 110 (e.g., instead of the mid-plate 135). Similarly, the mid-plate 135 may have apertures 1905 (see FIG. 19) that receive dowels or bolts that are attached to the motor frame 110, to secure the mid-plate 135 to the motor frame 110. For example, the mid-plate 135 and end-plate 140 may either (1) receive the same bolts from the motor frame 110 (e.g., same bolt extends from motor frame 110 through aligned apertures in the mid-plate 135 and end-plate 140) or (2) have different dowels or bolts (e.g., one set for the mid-plate 135 and a second set for the end-plate 140). Thus, the retaining members 310 may advantageously help a user align and easily couple the end-plate 140 to motor frame 110 with the mid-plate 135 in-between.

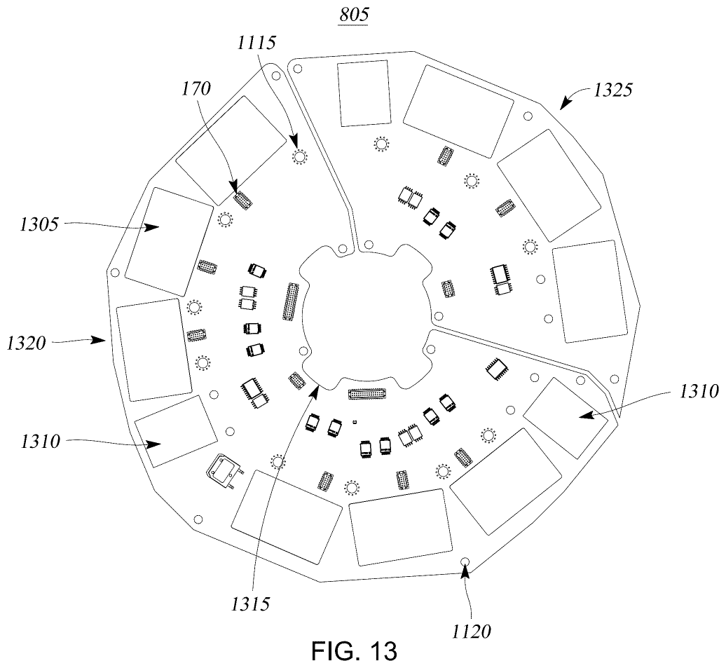

The conductive cover 220 may have one or more protruded sections 320A, 320B, and/or receded sections 325A, 325B. Each of the protruded sections 320A, 320B and receded sections 325A, 325B may advantageously correspond to one or more electronic components. For instance, if an electronic component mounted within the end-plate 140 is shorter than the space provided between the PCB board to which the electronic component is mounted and the main surface of the conductive cover 220, the conductive cover 220 may have a receded section 325A, 325B extending towards the electronic component (e.g., a power quality filter component), bringing the electronic component into physical contact with the conductive cover 220. For example, in the illustrated embodiment, the two clamp capacitors 1310 capacitors 1310 (see FIG. 13) are shorter than other electronic components mounted to the PCB board of the control layer 805 (see FIG. 13) and the main surface of the conductive cover 220 (e.g., shorter than the power quality capacitors 1305). To compensate for the disparity in length, the one or more clamp capacitors 1310 are each mounted to the PCB board of the control layer 805 on a first end of the respective clamp capacitor 1310 and contact a corresponding receded section 325A or 325B of the conductive cover 220 on a second end of the respective clamp capacitor 1310. Thus, the one or more clamp capacitors 1310 may effectively dissipate heat via the conductive cover 220 while being mounted next to longer electronic components.

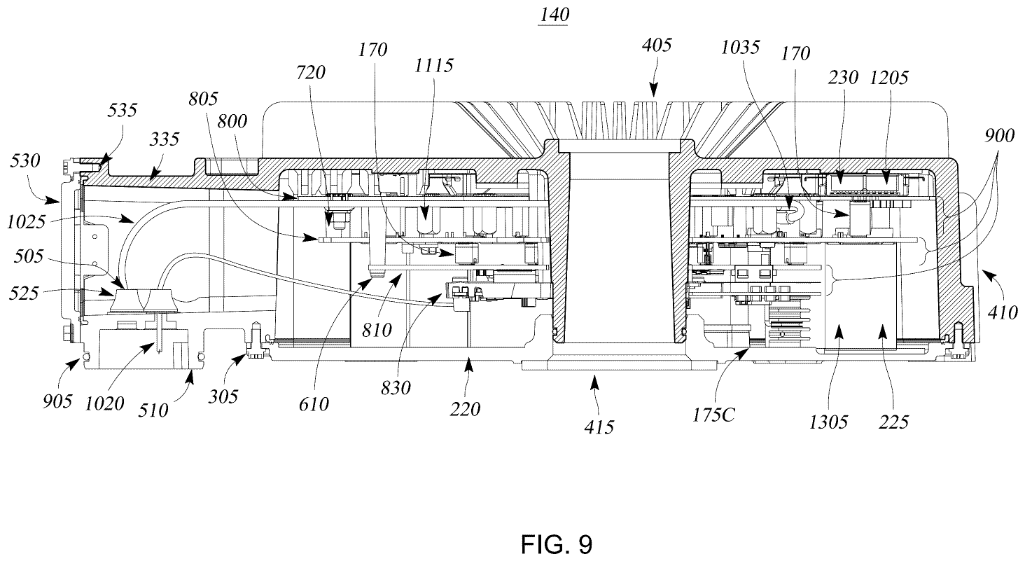

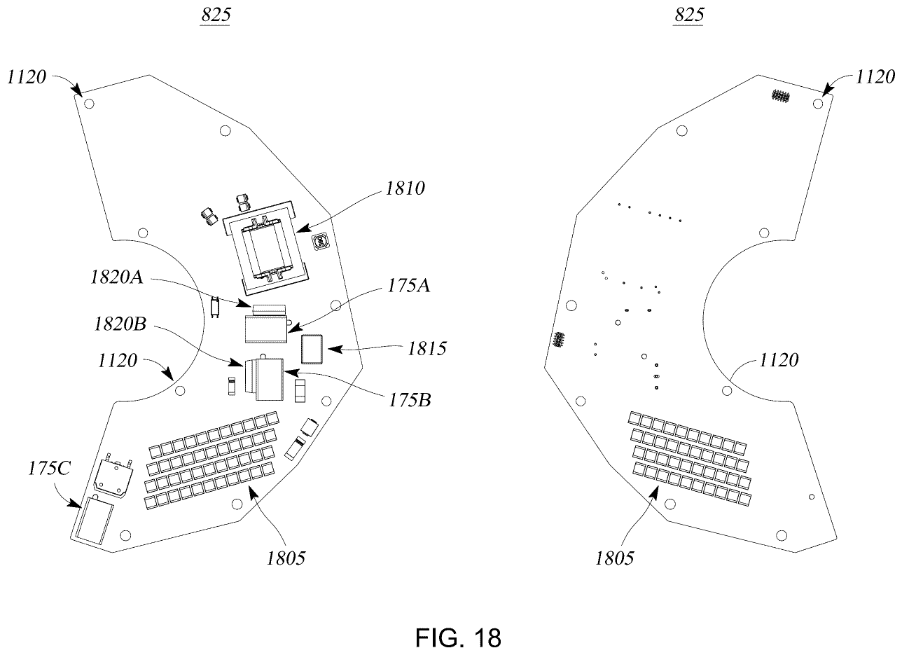

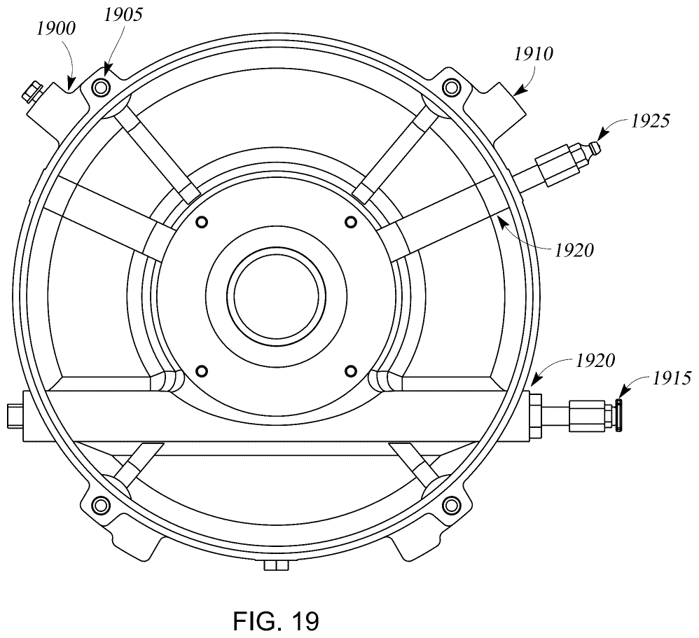

In some embodiments, if the electronic component is taller than the space provided between the PCB board to which the electronic component is mounted and the main surface of the conductive cover 220, the conductive cover 220 may have protruded sections 320A, 320B to accommodate the taller electronic component. For example, in the illustrated embodiment, one or more heat sinks 175A, 175B, 175C may be longer than other electronic components mounted to the PCB board 825 (see FIG. 9 and FIG. 18) and the main surface of the conductive cover 220. To compensate for the disparity in length, the heat sinks 175A, 175B, 175C are mounted to the PCB board 825 on a first end of each respective heat sink 175A, 175B, 175C and contact a corresponding protruded section 320A (heat sinks 175A, 175B) or 320B (heat sinks 175A, 175B) of the conductive cover 220 on a second end of the respective heat sink 175A, 175B, 175C. Thus, the heat sinks 175A, 175B, 175C may effectively dissipate heat via the conductive cover 220 while being mounted next to shorter electronic components.

Thus, electronic components of different dimensions may be used without disrupting the thermal pathways for dissipating heat (e.g., from the low temperature components 225 to the conductive cover 220 to the thermal insulation gap 215/external environment). Similarly, the heat sinks 175A, 175B, 175C (see, e.g., FIGS. 10A and 10B) may be in physical contact (e.g., be thermally coupled) to the conductive cover 220 (see, e.g., FIG. 9). Additionally, the physical contact between the electronic components and the conductive cover 220 may provide additional mechanical support for the electronic components to secure them in place. For example, the physical contact may prevent the electronic components from disconnecting or flexing due to the vibrations cause by the motor 105.

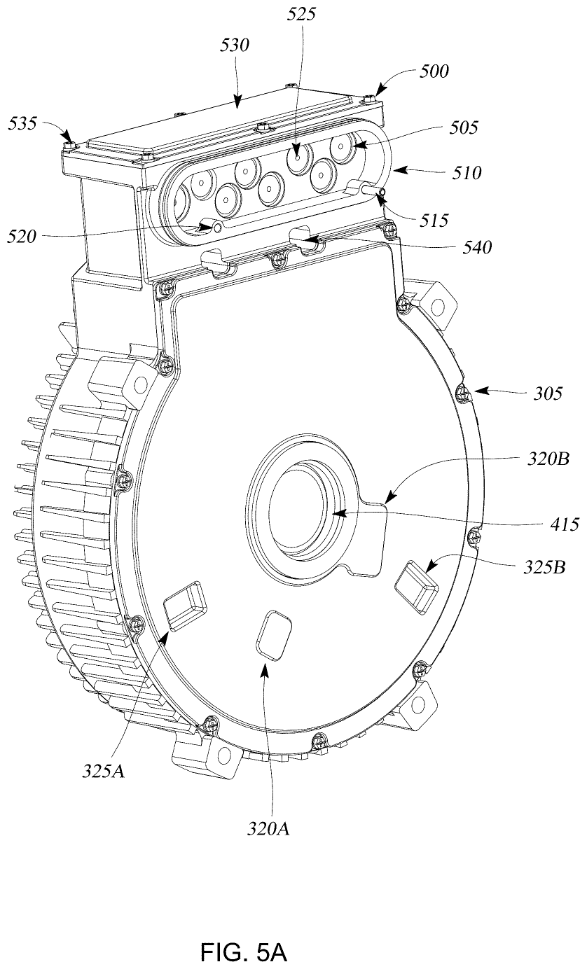

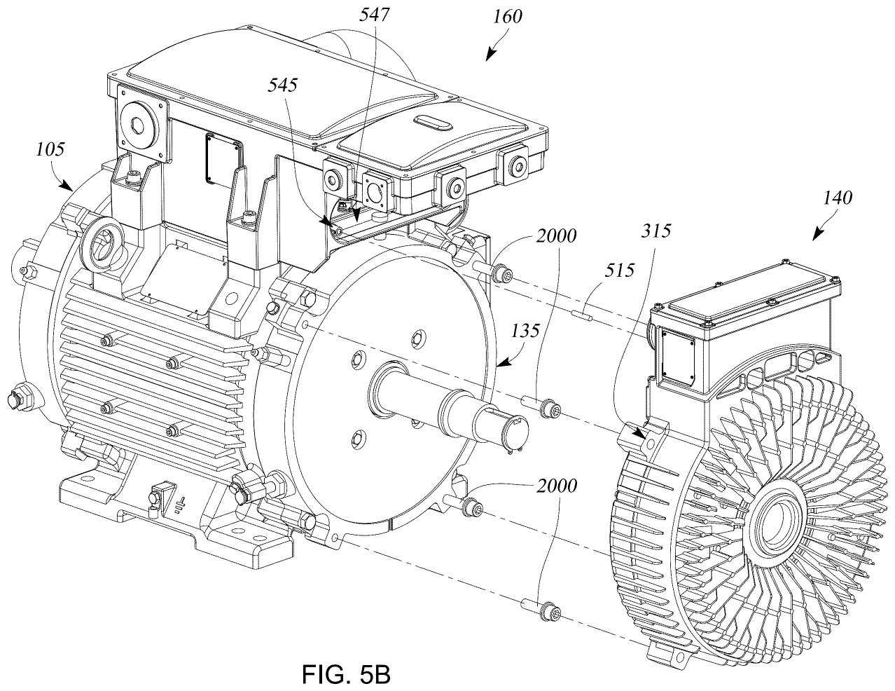

FIG. 4 and FIG. 5A are a back view and a front perspective view, respectively, of the end-plate 140 of the motor assembly 100 of FIG. 1. As described above, the end-plate 140 may have an opening 415, radial cooling fins 405 on the back side or surface of the end-plate 140, and peripheral cooling fins 410 on the side of the end-plate 140. In some embodiments, the end-plate 140 may have a wiring terminal 500 that may couple to the terminal box 160. The wiring terminal 500 may have one or more terminal points 505. For example, the wiring terminal 500 may have one, two, four, eight, ten, twenty, or more than twenty terminal points 505, or any number in-between. In some embodiments, the openings of terminal points 505 may include self-sealing grommets 525. The self-sealing grommets 525 may advantageously prevent moisture, dust, grease, and/or excess heat from entering the wiring terminal 500.

In some embodiments, the wiring terminal 500 has a top cover 530. The top cover 530 may include a gasket and may be attached to the wiring terminal 500 by one or more fasteners 535 (e.g., screws, magnets, snap-fit, etc.). Removing the top cover 530 allows a user to quickly install and repair any connections inside the wiring terminal 500. In some embodiments, the wiring terminal 500 is water-proof and dust-proof when the top cover 530 is attached. For example, the end-plate 140 and wiring terminal 500 may have a high ingress protection (IP) rating (e.g., IP 66) and not allow any dust and/or water to enter. Alternatively, the end-plate 140 and wiring terminal 500 may have a lower IP rating (e.g., IP 55) when the motor assembly 100 is being installed in less harsh environments.

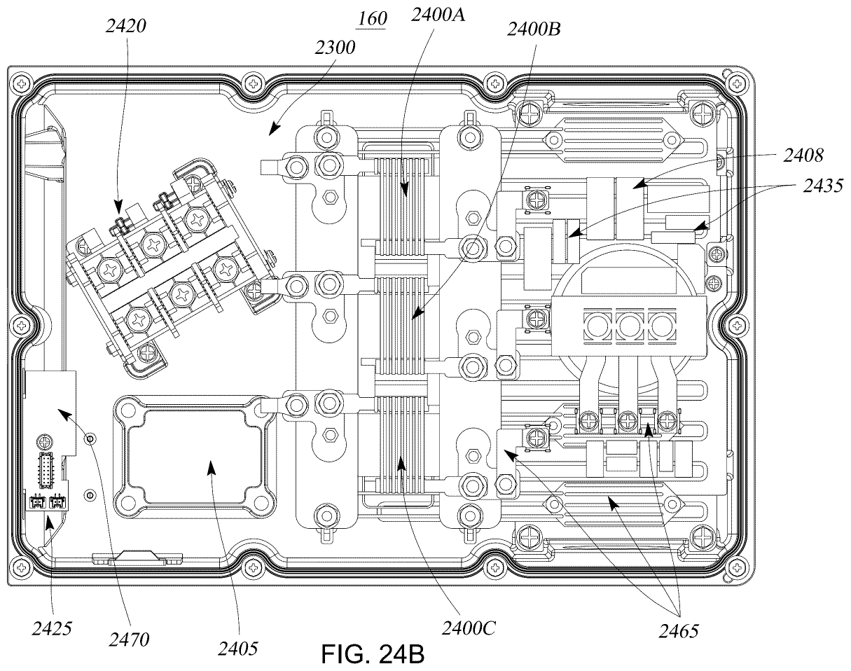

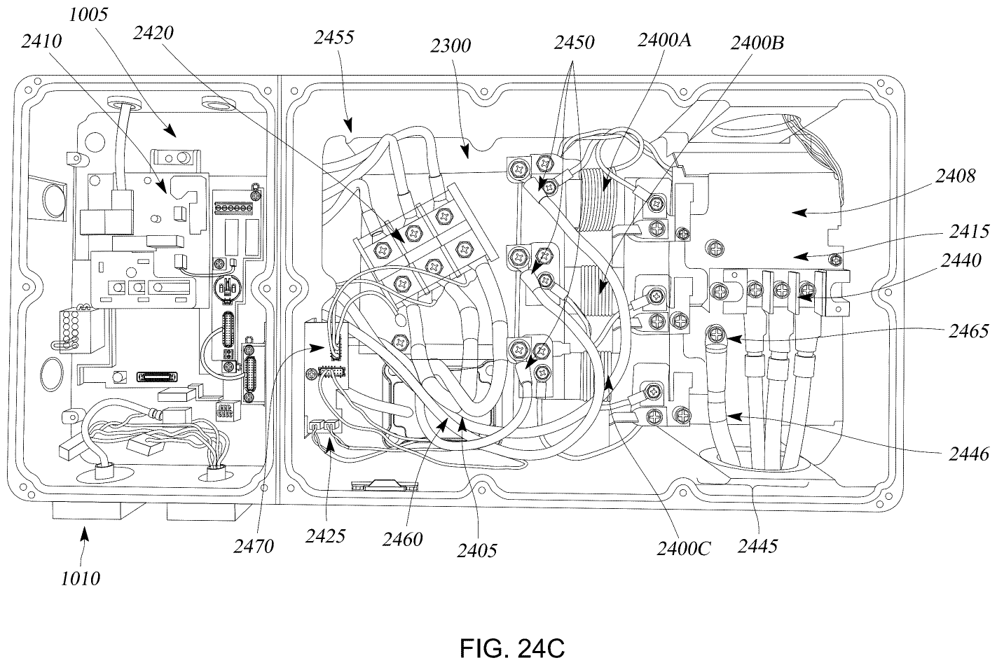

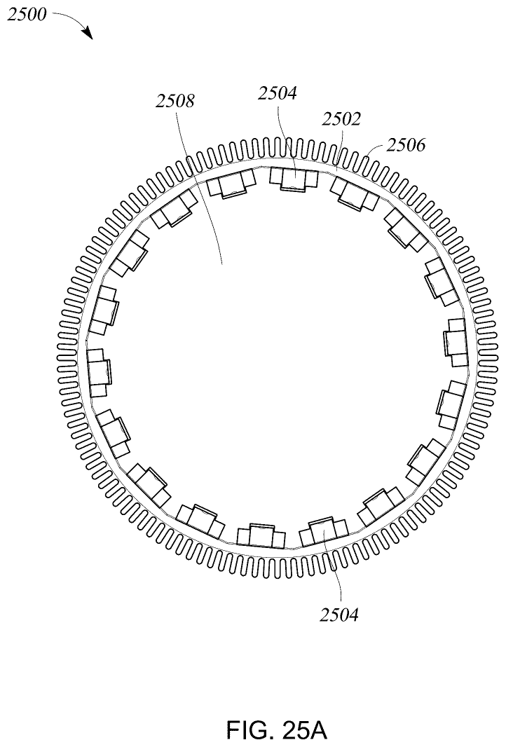

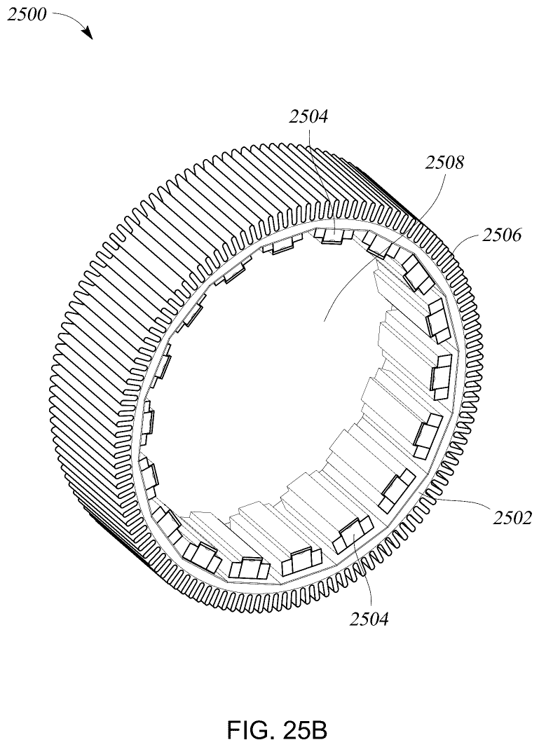

The wiring terminal 500 may have one or more retaining members 520 comprising an aperture. The retaining members 520 can receive dowels or other elongate guide members 515 which can couple to corresponding aperture of the terminal box 160. In the embodiment illustrated in FIGS. 24A-25, the guide member 515 is a dowel 515 configured to couple to an aperture in the terminal box 160, and to guide alignment of the end-plate 140 with the mid-plate 135 and motor frame 110. While FIG. 5A only shows the rightmost retaining member 520 including a dowel 515, the other retaining member 520 can also include a dowel (as shown in FIG. 1).

FIG. 5B is an exploded perspective view of the motor 105, terminal box 160, mid-plate 135, and end-plate 140. As described in more detail below, the mid-plate 135 may be attached to the motor 105 via screws 2000, bolts, or other retaining hardware. During installation of the end-plate 140, the user can insert the dowels 515 into corresponding retaining members 545 on the terminal box 160, facilitating alignment of the end-plate 140. Then the user can insert threaded bolts through the apertures 315 for threaded mating with the corresponding apertures 2100 of the mid-plate 135 (which are aligned with the apertures 315 through the use of the dowels 515), thereby fastening the end-plate 140 to the mid-plate 135. In other embodiments, the gender of the guide features can be reversed, e.g., such that the dowels or other male elongate guide members 515 are held in the motor frame 110 and the end-plate 140 has apertures configured to receive the guide members 515 during installation.

For example, the end-plate 140 can include guides 315 that can mate with corresponding apertures on the terminal box 160 that are shaped to mate with the guides 315, thereby facilitating alignment of the end-plate 140 prior to fastening the end-plate 140 to the mid-plate 135 using the bolts of the end-plate mounting hardware EMH. The guides 315 are the fixed conduits 315 that form the wire channels, instead of dowels. In other embodiments, the gender of the guide features can be reversed, e.g., the terminal box 160 can include conduits that form the wire channels and the end-plate 140 can include corresponding apertures to receive the conduits that form the wire channels. Alternatively, or in addition, the wiring terminal 500 may use snap-fit connectors, magnets, screws, or any other type of fasteners to couple to the terminal box 160, mid-plate 135, fan 145, and/or any other component of the motor assembly 100.

Referring again to FIG. 5A, in some embodiments, the wiring terminal 500 includes a connection flange 510 and a gasket 905 (see FIG. 9) that facilitates coupling with the terminal box 160. For example, the terminal box 160 may have a corresponding receptacle to receive a connection flange 510. It should be understood that gaskets may be placed in-between any coupled components to prevent dust, water, grease, and/or excess heat from damaging the motor 105 and electronic components.

Referring to FIGS. 5A and 5B, the terminal box 160 can include an opening 547 that receives and mates with the flange 510 of the end-plate 140. The wiring terminal 500 generally facilitates electrical connection between electronics within the end-plate 140 and electronics within the terminal box 160. For instance, for each connection point 505 of the wiring terminal 500, a corresponding wire can extend within the end-plate 140 from a connection to electronics within the end-plate 140, through the grommet 525 of the connection point 505, into the opening 547 of the terminal box 160, and finally within the terminal box 160 to connect to electronics within the terminal box 160.

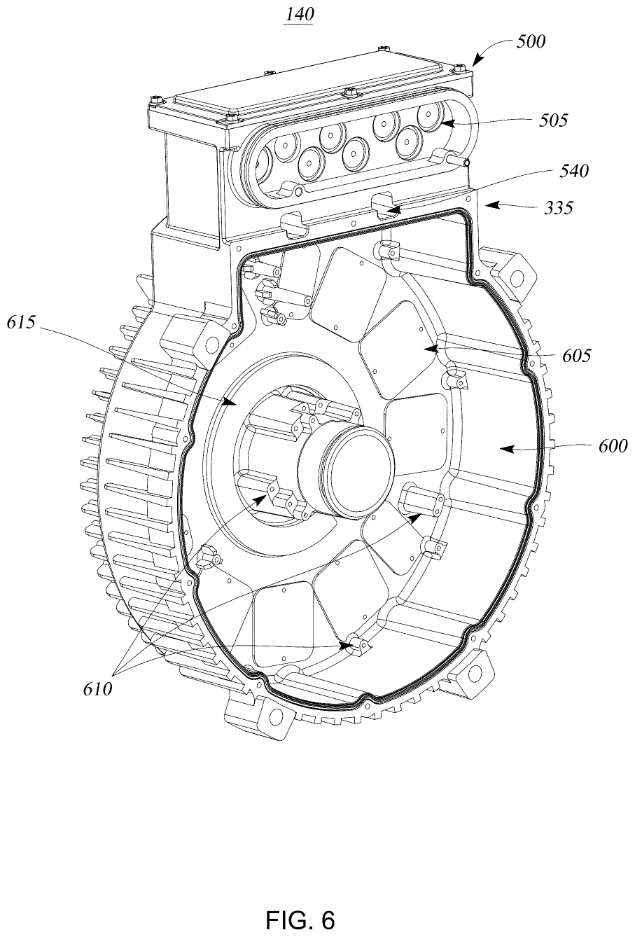

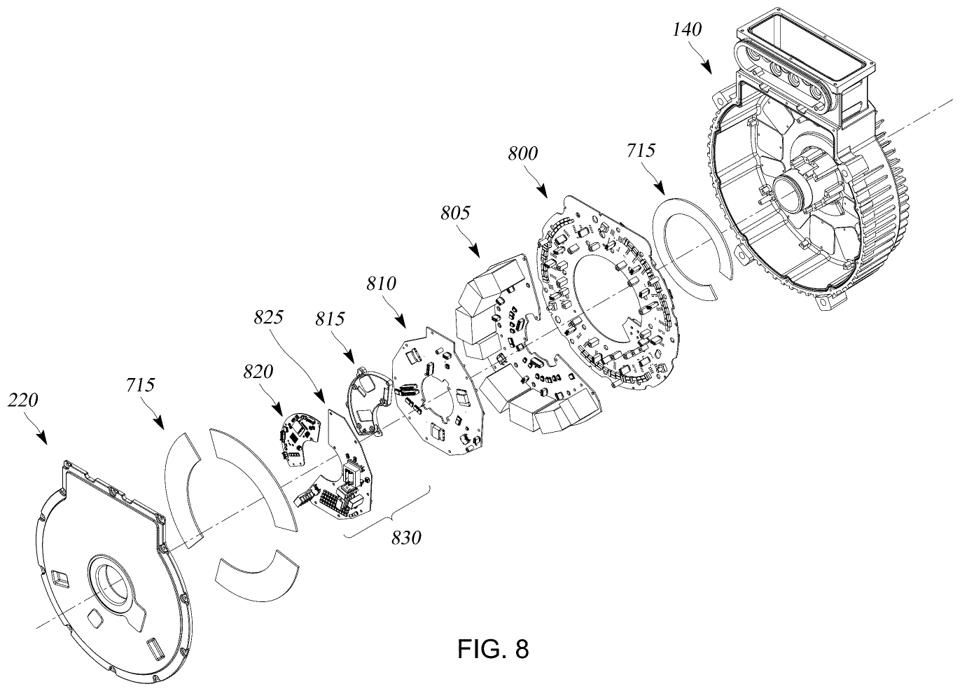

FIG. 6 is a perspective view of the end-plate 140 of the motor assembly 100 of FIG. 1 with the conductive cover 220 removed. In some embodiments, the end-plate 140 may have one or more ventilation channels 540 to allow air flow from the fan 145 to reach the terminal box 160. The air flow in the ventilation channels 540 may also, or alternatively, cool the end-plate 140. In some embodiments, the end-plate 140 may have a space envelope 600 (e.g., a hollow internal area with a periphery defined by a peripheral wall of the end-plate housing 335, a rear wall of the end-plate housing 335, and the cover 220). A gasket (not shown) may be interposed between the conductive cover 220 and the end-plate housing 335 to advantageously prevent moisture, dust, grease, and/or excess heat from entering the space envelope 600. The space envelope 600 may include contact surfaces 605 for the electronic components or other hardware. In some embodiments, the contact surfaces 605 can each comprise one or more layers of conductive epoxy pads. For example, the contact surfaces can be adapted to make contact with the top of the packages of corresponding components on the power layer 800, such as the power modules 1205 and the sensing modules 1206 (see, e.g., FIGS. 8, 9, and 12). Where the contact surfaces 605 are heat conductive, the contact of the top of the components with the corresponding contact surfaces 605 can help draw heat away from the components, onto the back wall of the end plate 140, and out of the end-plate 140, e.g., via the cooling fins 405, 410 of the end plate housing 335. The contact surfaces 605 may each have different dimensions and may protrude (e.g., 1 mm-10 mm) into the space envelope 600 to better accommodate different electronic components. The space envelope 600 may also, or alternatively, have attachment points 610 for the multi-board power plane 200. For example, the attachment points 610 may protrude different amounts for the different levels of the multi-board power plane 200. In some embodiments, the end-plate 140 may have a toroidal-shaped conductive epoxy pads 615 to provide additional heat diffusion (e.g., from the busbar 180 to the end-plate housing 335).

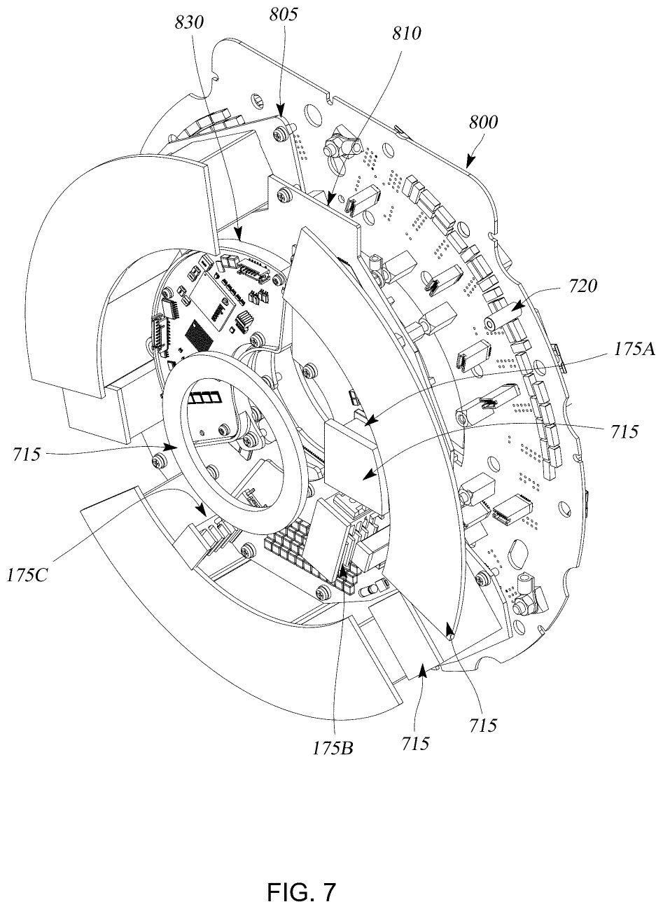

FIG. 7 is a perspective view of the multi-board power plane 200 and the corresponding electronics, dimensioned to fit within the space envelope 600 of the end-plate housing 335. As described above, the multi-board power plane 200 may include one or more control layers and one or more power layers. For example, the multi-board power plane 200 may have a control layer 805, a second control layer 810, a third control layer 830, and a power layer 800. The multi-board power plane 200 may have one or more spacers 720 in-between the layers. In some embodiments, the end-plate 140 includes one or more conductive epoxy pads 715. The conductive epoxy pads 715 may be made of any conductive material (e.g., silver-filled resin) and may be interposed between the conductive cover 220 and the low temperature components 225 and/or heat sinks 175A, 175B, 175C to increase heat diffusion and prevent the low temperature components 225 from overheating. In some embodiments, the conductive epoxy pads 715 are interposed between one or more components and the protruded sections 320A, 320B and/or receded section 325A, 325B (see FIG. 3) of the conductive cover 220. For example, the conductive epoxy pads may be interposed between the heat sinks 175A, 175B, 175C, input filter capacitors 1305, and/or clamp capacitors 1310 (see FIG. 13). It should be understood the conductive epoxy pads 615, 715 may be thermally conductive while being electrically insulative.

FIG. 8 is an exploded view of the end-plate 140 and its internal components including the multi-board power plane 200. In some embodiments, each layer of the multi-board power plane 200 consists of a PCB. Alternatively, or in addition, one or more of the layers may consist of two or more PCB boards. For example, the third control layer 830 may consist of a control PCB board 820 with a housing 815 and a switched-mode power supply 825. The housing 815 may provide additional support for the control PCB board 820, and/or thermal and electric insulation from other electronic components.

In some embodiments, the PCBs of the multi-board power plane 200 are double-sided PCBs with electronic components on both sides. The PCBs may also, or alternatively, be single-sided PCBs or multi-layered PCBs that advantageously allow complex circuits within a small area. Additionally, the PCBs may be made of either rigid or flexible materials. For example, the PCBs may be made of copper, fiberglass, epoxy resin, polyester resin, and/or any other material described herein. In some embodiments, the multi-board power plane 200 may be a toroidal-shaped assembly to advantageously fit in the space envelope 600 of the end-plate 140 while providing interconnections for the input/output power, current sensors, gate driver, clamp control circuit, power/clamp semi-conductor modules, clamp resistors, busbars, and power quality capacitors. In some embodiments, the electronic components (e.g., the power quality filters and/or power modules) are mounted about the center of the multi-board power plane 200 (e.g., in a circular pattern). Furthermore, the multi-board power plane 200 may have an opening to allow the shaft of the motor rotor 115 to pass through.

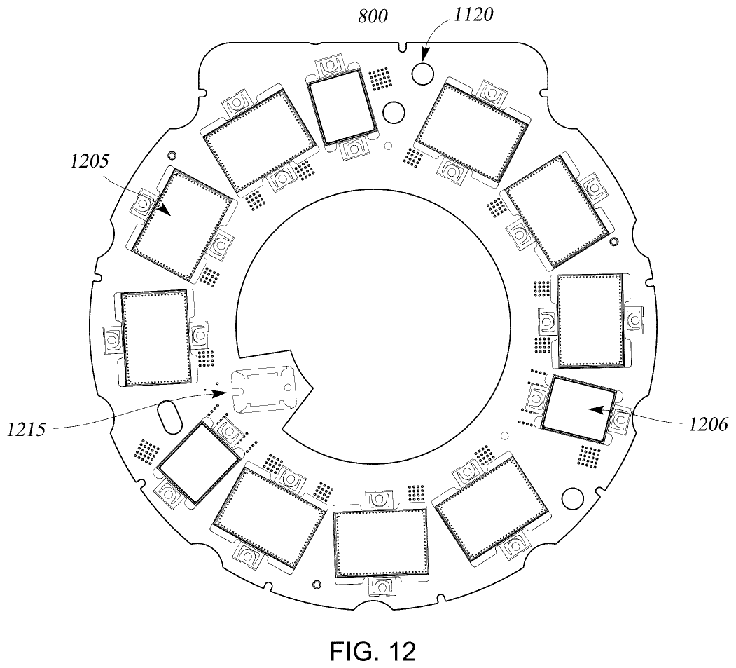

FIG. 9 is a cross-section view of the end-plate 140 and its internal components (e.g., multi-board power plane 200 and/or some or all of the variable frequency drive electronics unit). In some embodiments, the multi-board power plane 200 includes one or more thermal insulation air gaps 900. The thermal insulation air gaps 900 prevent the heat from the power layer 800 and the high temperature components 230 from damaging the low temperature components 225. The exemplary low temperature component 225 referred to in the cross-section of FIG. 9 is a power quality capacitor 1305 (see, e.g., FIG. 13). The exemplary high temperature component 230 referred to in the cross-section of FIG. 9 is one of the power modules 1205 (see, e.g., FIG. 12). The thermal insulation air gaps 900 may have a thickness of 5 mm, 10 mm, 20 mm, 30 mm, 50 mm, or more than 50 mm, or any thickness in-between. For example, the thermal insulation air gap 900 between the power layer 800 and the control layer 805 may be 20 mm, and the thermal insulation air gap 900 between the control layer 805 and the second control layer 810 may be 12 mm. In some embodiments, the thermal insulation air gaps 900 allow the multi-board power plane 200 to satisfy creepage and clearance standards. Thus, the thermal insulation air gaps 900 advantageously prevents high voltage components from electrically interfering with or damaging other electronic components. In some embodiments, the attachment points 610, spacers 720, power connectors 1115, and/or data connectors 170 may be used separate the layers from one another to create the thermal insulation air gaps 900.

FIG. 10A and FIG. 10B are front cross-section views (mid-plate 135 side) of the end-plate 140 and of the portion of the terminal box 160 that overhangs the mid-plate 135 and mates with the flange 510 and wiring terminal 500 of the end-plate 140. As shown in FIG. 10A and FIG. 10B, the multi-board power plane 200 may be generally toroidal-shaped and have a stack configuration so that the required electronic components and connectors can easily fit within the space envelope 600 of the end-plate 140. For example, all the PCB boards of the multi-board power plane 200 may be toroidal-shaped with an opening in the middle. The periphery of the end-plate 140 may be shaped to match and mate with the form factor of the motor 105 and terminal box 160. The terminal box 160 may connect to the wiring terminal 500. In some embodiments, the terminal box 160 may have a first electronic compartment 1005 that is positioned above the wiring terminal 500. The multi-board power plane 200 may communicate to electronic components in the terminal box 160 via the terminal points 505. In some embodiments, the terminal points 505 may allow for electrical connection between the terminal box 160 and the multi-board power plane 200. For example, in FIG. 9 and FIG. 10B a cable 1020 extending from the terminal box 160 is routed through one of the terminal points 245 to connect to an I/O port 1030 of the multi-board power plane 200. Alternatively, or in addition, one or more of the terminal points 505 may be used to route power cables from the terminal box 160 to the multi-board power plane 200. For example, a power cable 1025 may be routed through the terminal point 505 to connect to the ground terminal 1035. Alternatively, or in addition, the terminal box 160 may have one or more connectors 1010 with protective covers 1015. The terminal box 160 and connectors 1010 will be discussed in more detail below.

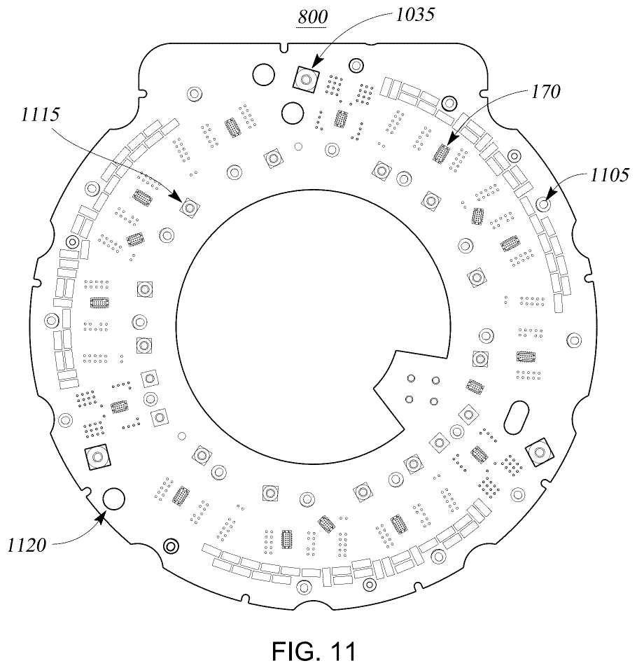

FIG. 11 is a front view (e.g., mid-plate 135 side) of the power layer 800 of the multi-board power plane 200. The power layer 800 may include one or more data connectors 170, component attachment points 1105, support apertures 1120, power connectors 1115, and/or ground terminal 1035. The component attachment points 1105 may allow electronic components to be mounted onto the board. Alternatively, or in addition, the electronic components may be surface mounted. In some embodiments, the support apertures 1120 may be mounting holes used to mount the power layer 800 onto the end-plate 140. The support apertures 1120 may also, or alternatively, allow one or more raised attachment points 610 (see FIG. 6) to pass through a support aperture 1120 and connect to a different PCB (e.g., the control layer 805) in the multi-board power plane 200. In some embodiments, the opening 1110 allows the power layer 800 to encircle the central column 235 of the end-plate 140.

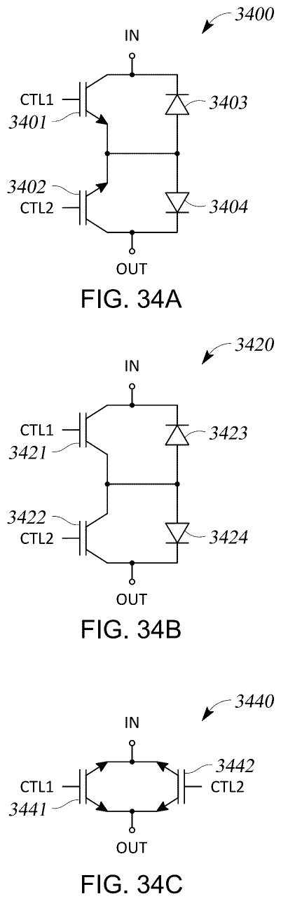

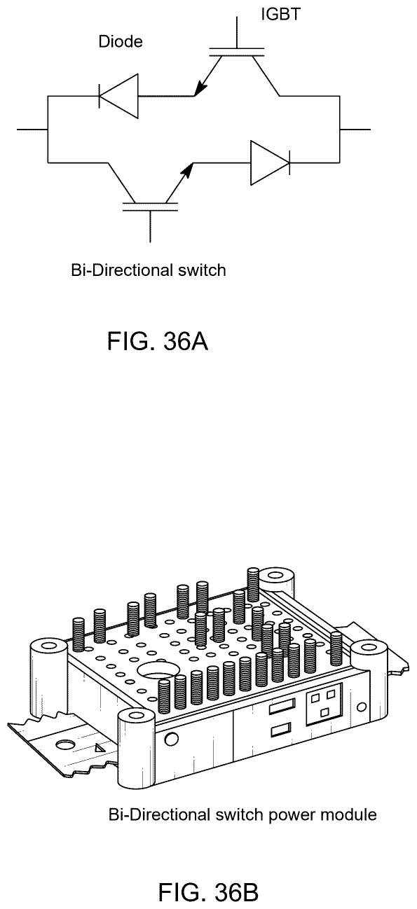

FIG. 12 is a back view (e.g., fan 145 side) of the power layer 800 of the multi-board power plane 200, which can include one or more components of the matrix converter (e.g., any of the matrix converters of FIGS. 31, 32, 33 or 35). In some embodiments, for example, the power layer 800 has one or more power modules 1205 and one or more current sensing modules 1206 current sensing modules 1206. For example, the power modules 1205 may include one or more power converters, power semi-conductors, and/or bi-directional switches (e.g., like the switches and/or power modules of FIGS. 34A-34C or 36A-36B). In some embodiments, the power modules 1205 are one component of the matrix converter and communicate with other components (e.g., in the terminal box 160 and on other PCBs) to create the full matrix converter. As described above, the matrix converter can receive AC input signaling and provide converted AC signaling having a converted AC waveform with a converted voltage and frequency to drive the motor 105. For example, the matrix converter can be a direct AC-AC matrix converter without an intermediate DC stage.

The arrangement and distribution of the components of the matrix converter may allow the motor 105 to run efficiently while the end-plate 140 and/or the mid-plate 135 and end-plate 140 together maintain a small overall form factor (e.g., a length and diameter that complies with industry standards). As shown, the power modules 1205 may be positioned in a circular arrangement. The power modules 1205 may be in contact with the end-plate housing 335 to effectively transfer heat from the high temperature components 230 to the cooling fins 405, 410 of the end-plate housing 335. This is illustrated, for example, in FIG. 9, where the power module 230 is in contact with the end-plate housing 335. Furthermore, the power layer 800 may include one or more input filter capacitor connectors, a clamp IGBT connectors, shunt resistor connectors 1215, and/or an output clamp diode connector. The power modules 1205 (larger rectangles) may correspond to the bi-directional switches of the arrays of switches 3102, 3302, 3502 of FIGS. 31, 33, and 35, for example, and can be or can include any of the switches of FIGS. 34A-34C, 36A or the power module of FIG. 36B. The current sensing modules 1206 in some embodiments include resistive shunts, although other types of current sensors are possible.

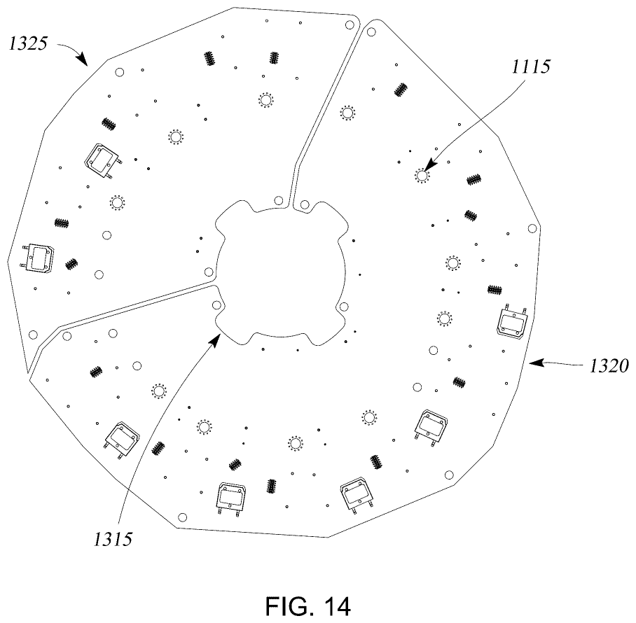

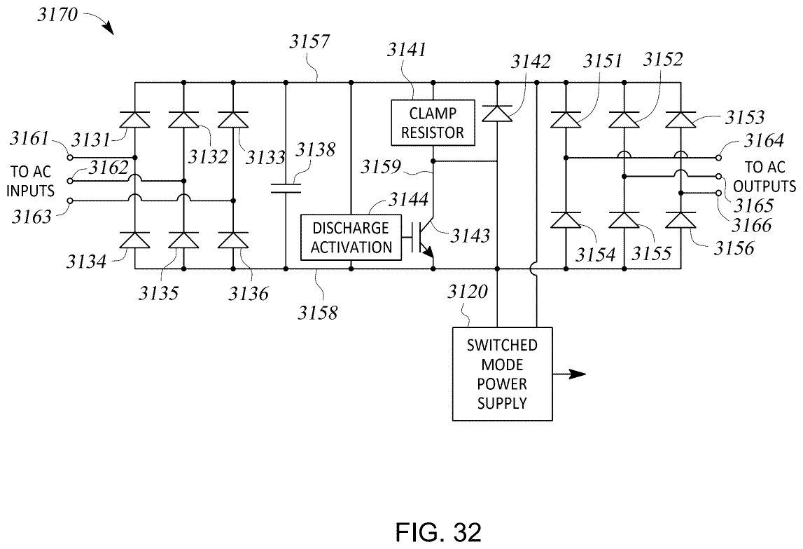

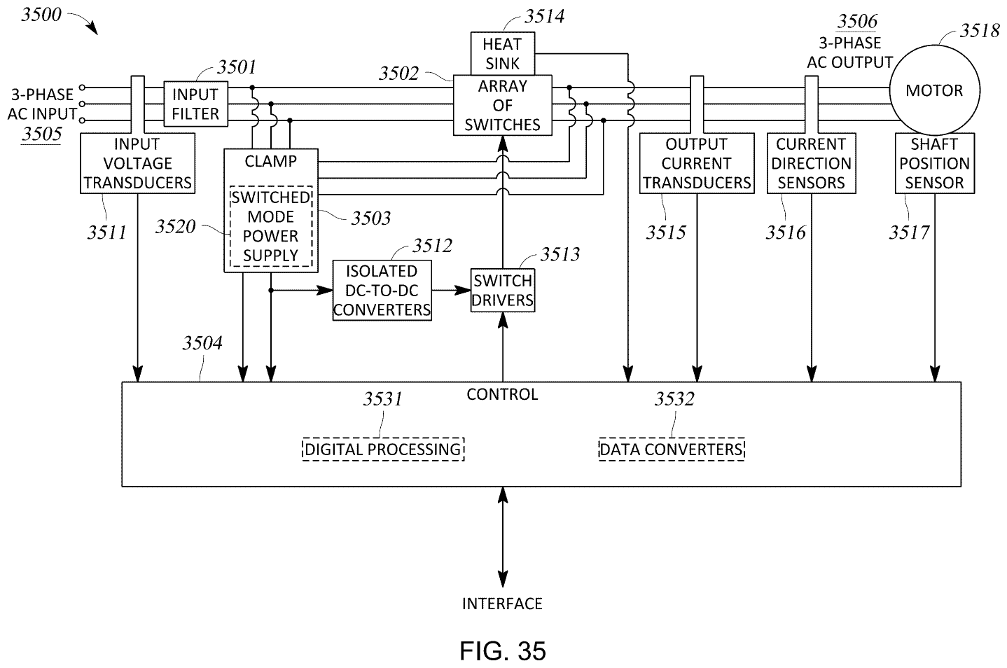

FIG. 13 and FIG. 14 are front and back views, respectively, of the control layer 805 of the multi-board power plane 200, which, like the power layer 800, can include one or more components of the matrix converter. The control layer 805 may include one or more input filter capacitors 1305, clamp capacitors 1310, data connectors 170, support apertures 1120, and/or power connectors 1115. In some embodiments, the electronic components of the control layer 805 may be used as power quality filter components (e.g., the input filter capacitors 1305). As described above, the control electronic modules may be positioned in a circular arrangement and may be in contact with the conductive cover 220 to effectively transfer heat from the low temperature components 225 (e.g., the capacitors 1305, 1310) into the external environment. It should be understood that the control layer 805 may also, or alternatively, have one or more power quality filters, power quality capacitors, peak supporters, input phase wires, shunt resistors, clamp modules, clamp resistor wires, gate driver power supply, controller cards, copper connectors, current sensors, gate drivers, power supply, and/or any other control electronics module/power qualify filter components. Furthermore, the control electronic modules and electronic components described herein may be distributed or positioned in any configuration among the various PCB boards, including on either side of the boards. Alternatively, or in addition, any of the electronic components may be distributed or positioned in the terminal box 160 (e.g., one or more power modules may be in the terminal box 160 in some other embodiments). The input filter capacitors 1305 may correspond to one or more of the capacitors 3115, 3116, 3117 of the input filter 3101 of FIG. 31 or to capacitors of the input filter 3501 of FIG. 35, for example. The clamp capacitors 1310 may correspond to the capacitor 3138 of FIG. 32, or to capacitors of the clamp circuits 3103, 3503 of FIGS. 31, 35.

In some embodiments, the control layer 805 is a two-part layer with a first PCB board 1320 and a second PCB board 1325. Separating the control layer 805 into two or more separate PCBs may offer several benefits, including improved accessibility for maintenance and repair, enhanced reliability by reducing the risk of a single point of failure, improved performance by using specialized materials/components for the different sides, and increased flexibility through a more modular design. In some embodiments, the control layer 805 may include a non-circular opening 1315 to allow the raised attachment points 610 of the end-plate housing 335 (See, e.g., FIG. 6) to reach the other layers of the multi-board power plane 200. The non-circular opening 1315 may also, or alternatively, allow one or more busbars or other components to reach the control layer 805 and/or the other layers.

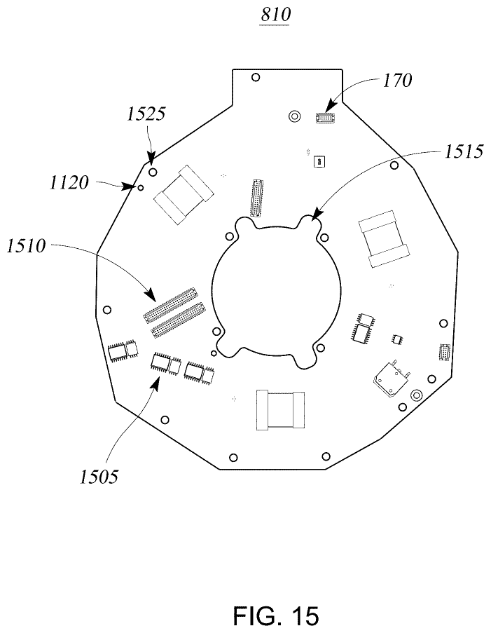

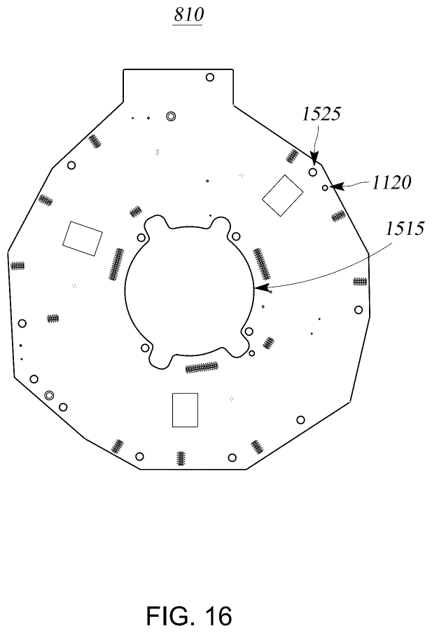

FIG. 15 and FIG. 16 are front and back views, respectively, of the second control layer 810 of the multi-board power plane 200. As described above, the second control layer 810 may include any of the electronic components (e.g., control electronic modules, data connectors 170, PCB mounting holes 1525, 1120) described herein. In some embodiments, the second control layer 810 is a clamp control PCB. Like the control layer 805 and the power layer 800, the second control layer 810 may include or one or more components of the matrix converter. Alternatively, or in addition, the second control layer 810 may include a microprocessor interface 1510 to connect to a microprocessor of the third control layer 830. In some embodiments, the second control layer 810 may be smaller than the other layers of the multi-board power plane 200. For example, the microprocessor interface 1510 can be a PCB-to-PCB connector allowing signals to pass from the second control layer 810 to the third control layer 830. The second control layer 810 may also, or alternatively, have a non-circular opening 1515 opening 1515 and non-circular support apertures 1525 support apertures 1525, 1120. In some embodiments, the opening 1515 of the second control layer 810 is circular and accommodates the central heat sink of the end-plate 140. However, the size of the layers may vary to accommodate different preferences and use cases. The second control layer 810 can further include one or more packaged integrated circuits 1505, which can perform control and drive functionality.

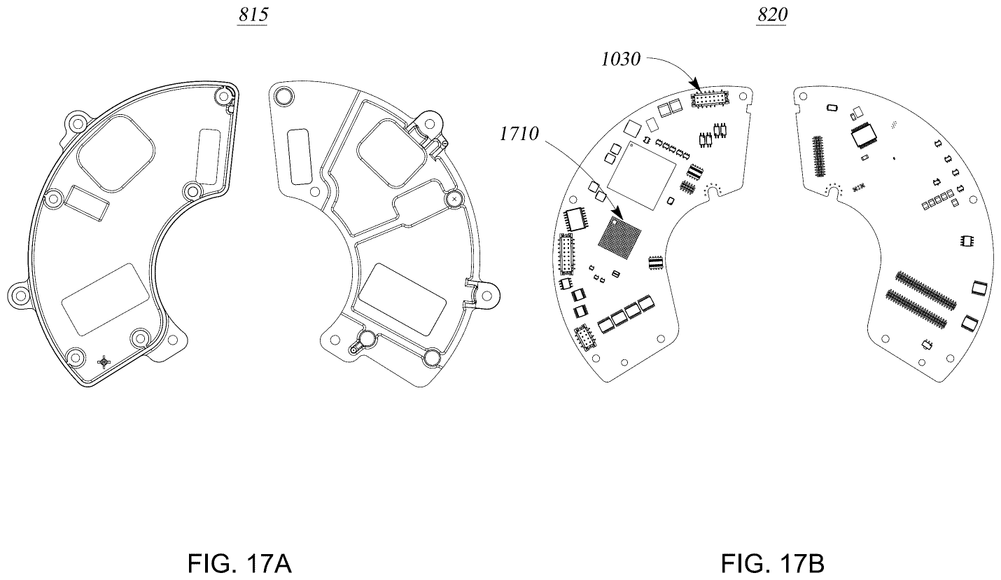

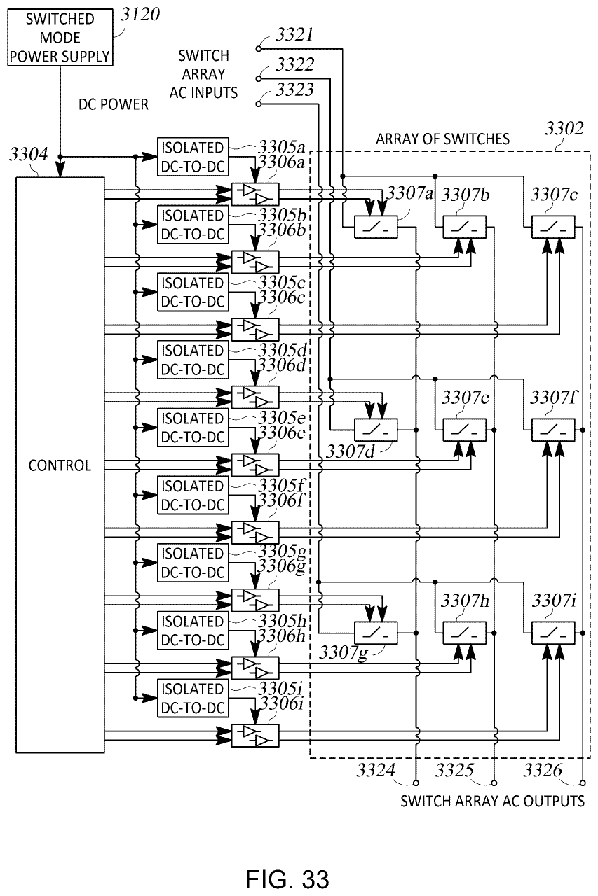

FIG. 17A illustrates a housing 815 of the third control layer 830 of the multi-board power plane 200. FIG. 17B illustrates a front and a back view of the control PCB board 820 housing 815 third control layer 830 multi-board power plane 200. For example, the PCB control board 820 can be a main control board for controlling the operation of the matrix converter and other components of the embedded motor drive electronics, including other components mounted within the end-plate 140. The housing 815 can be a plastic carrier for carrying the PCB control board 820. In some embodiments, the control PCB board 820 may include one or more integrated circuits 1710 integrated circuits 1710 mounted thereon. For example, one or more of the integrated circuits 1710 can comprise the main microprocessor of the multi-board power plane 200. The integrated circuits can include one or more field-programmable gate arrays, which can be programmable integrated circuits that can perform various digital logic functions and may consist of configurable logic blocks and programmable interconnects that allow field-programmable gate array 1710 to be customized for specific tasks, such as digital signal processing or control logic. In some embodiments, the PCB control board 820 may correspond to some or all of the control circuitry 3104 of FIG. 31, some or all of the control PCB of the control circuit 3304 of FIG. 33, and/or some or all of the control circuitry of the control block of FIG. 35.

In some embodiments, the control PCB board 820 may include any of the electronic components (e.g., control electronic modules, data connectors 170, support apertures 1120) described herein. Furthermore, the housing 815 may provide a physical barrier around the control PCB board 820, protecting it from external factors such as dust, moisture, and mechanical damage, which may extend the lifespan of the control PCB board 820 and improve the overall reliability of the multi-board power plane 200. The housing 815 may also, or alternatively, facilitate the dissipation of heat from the control PCB board 820 by acting as a heat sink. In some embodiments, the housing 815 may enhance the performance of the control PCB board 820 by improving signal integrity, power efficiency, and/or electromagnetic compatibility. It should be understood that any of the PCBs of the multi-board power plane 200 may have a housing.

FIG. 18 is a front and back view of the switched-mode power supply 825 of the multi-board power plane 200. In some embodiments, the switched-mode power supply 825 may be a power supply that efficiently converts an input voltage into a desired output voltage. It may be used to power the multi-board power plane 200 and the motor 105 by providing a stable, regulated voltage. The switched-mode power supply 825 may operate by switching one or more power transistors 1820B on and off at a high frequency, resulting in efficient power conversion with minimal losses. The power transistors 1820B may be metal-oxide-semiconductor field-effect transistors (MOSFETs). The switched-mode power supply 825 may include one or more diodes 1820A. The diodes 1820A and/or power transistors 1820B may be attached to corresponding heat sinks 175A, 175B. The heat sinks 175A, 175B, 175C may reduce the operating temperature of the power transistors 1820B and diodes 1820A to improve their efficiency and increase their lifespan.

In the illustrated embodiment, the switched-mode power supply 825 includes a switch mode transformer 1810, a plurality of power supply capacitors 1805, and a current sensor 1815. The switch mode transformer 1810, input filter capacitors 1305, clamp capacitors 1310 (see FIG. 13), and/or heat sinks 175A, 175B, 175C may be mounted to an epoxy pad 715 to improve heat diffusion and prevent the electronic components from overheating. As discussed above, one side of the epoxy pad 715 may be in contact with the conductive cover 220. The switched-mode power supply 825 may also include support apertures 1525, 1120, which can be PCB mounting holes. Overall, the control layers of the multi-board power plane 200 may be used to efficiently control the power provided to the motor 105.

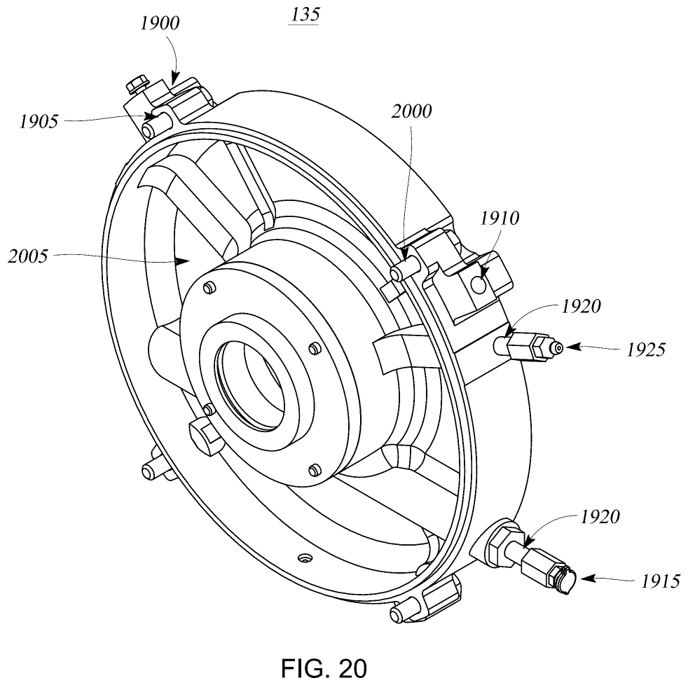

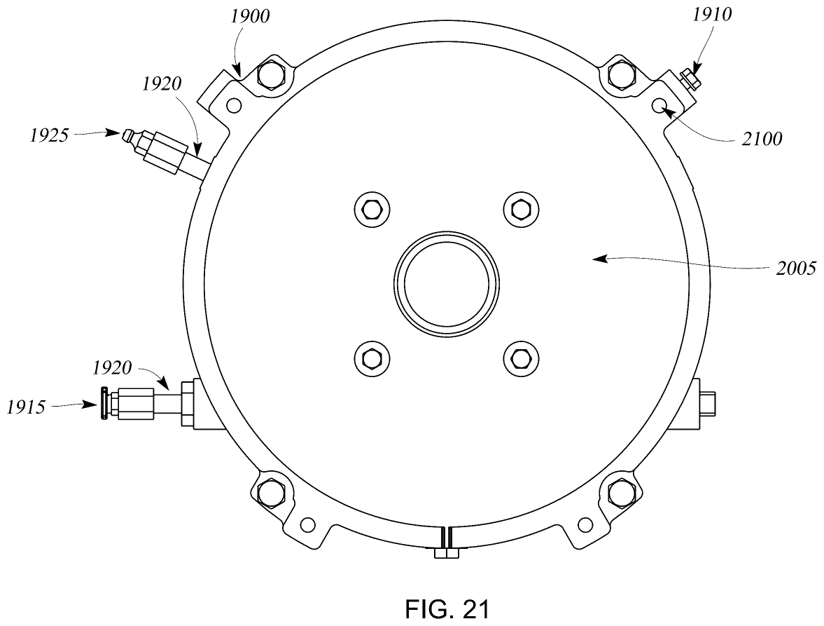

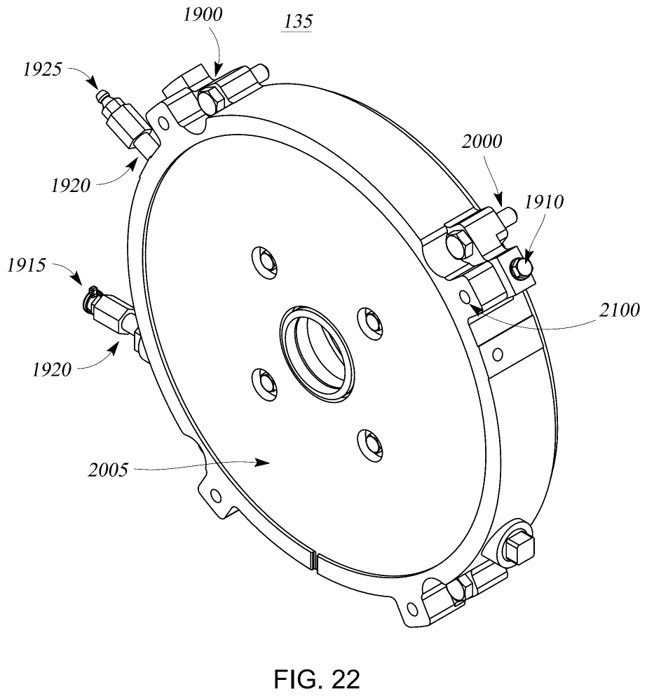

FIG. 19 and FIG. 20 are a front and front-perspective view, respectively of the mid-plate 135 of the motor assembly 100 of FIG. 1. FIG. 21 and FIG. 22 are a back and back-perspective view, respectively of the mid-plate 135 of the motor assembly 100 of FIG. 1. The mid-plate 135 may have a wall 2005. In some embodiments, the mid-plate 135 includes one or more bearing oil/grease tubes 1920. The grease tubes 1920 may include a service port 1925, 1915 for refilling or flushing the oil or grease. For example, service port 1925 may be a grease zerk fitting that allows input of fresh grease from a grease gun and service port 1915 may be a grease pressure release. That allows old grease to be expelled. The mid-plate 135 may also, or alternatively, have a wall and one or more retaining members 1900 (e.g., such as four retaining members 1900). The retaining members 1900 may be Z-shaped with three different apertures. The three different apertures may allow the mid-plate 135 to connect to the motor frame 110 (distal to the mid-plate wall 2005 wall 2005), the terminal box 160, and/or the end-plate 140 (proximate to the mid-plate wall 2005 wall 2005). For example, the first aperture 1905 (FIGS. 19 and 20) may receive a motor frame 110 fastener, the second aperture 1910 (FIGS. 19-22) may receive a terminal box 160 fastener, and the third aperture 2100 (FIGS. 21-22) may receive a dowel and/or an end-plate 140 fastener, as discussed previously, e.g., with respect to FIG. 3. In some embodiments, the retaining members 1900 may use screws 2000, bolts, rivets, snap-fit connectors, and/or magnets, to connect to other components. Additionally, or alternatively, the retaining members 1900 may receive a dowel in a friction fit. The other end of the dowel may be attached to the corresponding component. In some embodiments, a combination of any of the fastening methods described herein may be used.

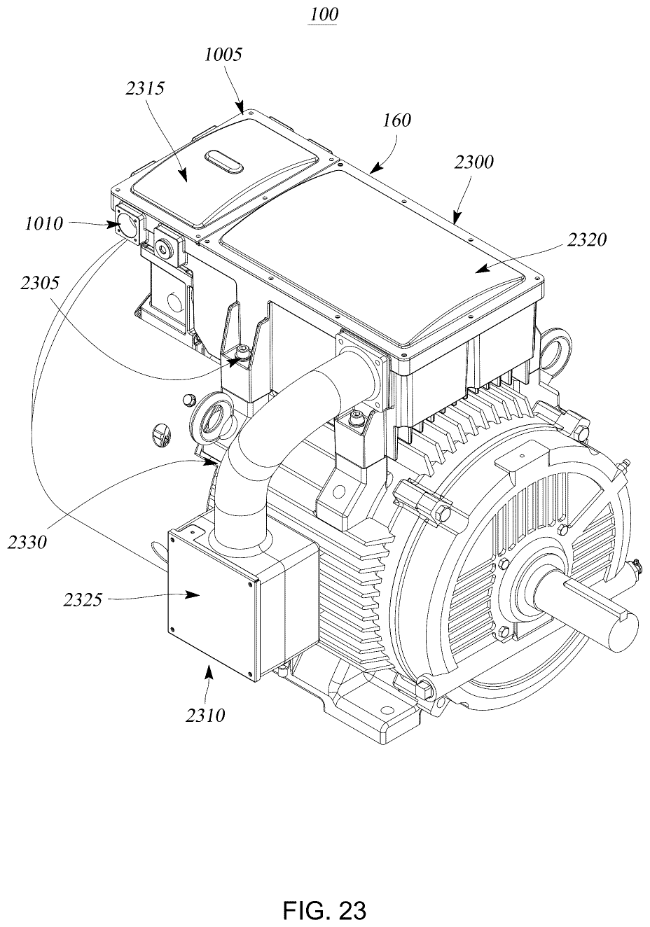

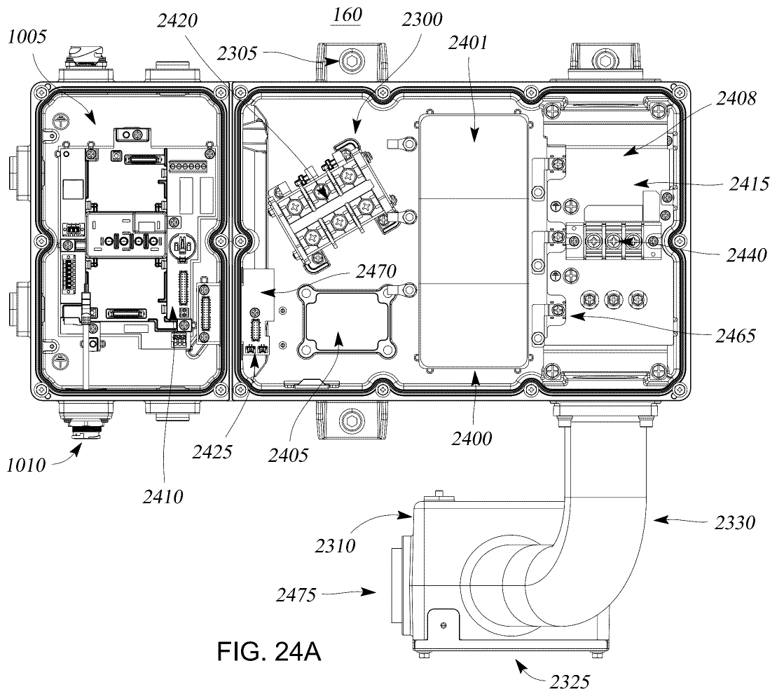

FIG. 23 is a perspective view of the motor assembly 100 of FIG. 1. In some embodiments, the terminal box 160 has a first electronic compartment 1005, a second electronic compartment 2300, and a third electronic compartment 2310. The three separate compartments may reduce electronic interference between the electronic components, as well as facilitate installation and repair of the motor assembly 100. In some embodiments, the third electronic compartment 2310 may be connected to the second electronic compartment via a protective conduit 2330. The three separate compartments may have removable lids 2315 lids 2315, 2320, and 2325 that may be used as heat sinks to cool the electronic components within the respective electronic compartment. The removable lids 2315, 2320, and 2325 may use any of the fastening methods described herein to couple to the respective terminal box 160 attachment points, as well as use gaskets to prevent dust, moisture, and/or grease from entering the motor assembly 100 and terminal box 160.

In some embodiments, the terminal box 160 has one or more attachment points 2305 to facilitate coupling with the rest of the motor assembly 100. The one or more attachment points 2305 may use any of the fastening methods described herein, as well as use gaskets to prevent dust, moisture, and/or grease from entering the motor assembly 100 and terminal box 160. As described above, the terminal box 160 may have one or more connectors 1010 (e.g., six connectors 1010). The connectors 1010 will be described in more detail below. In some embodiments, the motor assembly 100 may have multiple terminal boxes 160.

FIG. 24A is top view of the terminal box 160 of the motor assembly 100 of FIG. 1 with the lids 2315, 2320 removed. In some embodiments, the terminal box 160 has one or more electronic components that communicate with electronic components in the end-plate 140 to control the power provided to the motor 105. The terminal box 160 may have one or more inductors 2400 (e.g., three inductors 2400) that work with or that are part of the matrix converter, whereas the remaining components of the matrix converter are disposed within the end-plate 140. For instance, the inductors 2400 may be used to mitigate the transistor-switching noise generated by the matrix converter. In this capacity, the inductors 2400 may serve as low-pass filters, attenuating high-frequency noise while allowing the desired DC signals to pass through.

The inductors 2400 may be placed in series with the matrix converter's power modules 1205, or they may be connected in parallel with the load or other downstream components. By smoothing out the transistor switching noise, the inductors 2400 may improve the performance and reliability of the matrix converter. In some other embodiments, the inductors 2400 are disposed in the end-plate 140 such that the entire matrix converter is disposed within the end-plate 140. The inductors 2400 may correspond to the inductors 3111, 3112, 3113 of the input filter 3101 of FIG. 31 and/or the inductors of the input filter 3501 of FIG. 35, for example.

In some embodiments, the inductors 2400 are housed under a lid 2401. As shown, the terminal box 160 can further include an opening 2405 that allows for wire connections to pass between the motor 105 and the terminal box 160, an input power terminal block 2440 allowing for connection of the input grid power to the matrix converter, an output motor power terminal block 2420 allowing for connection of the output power delivered by the matrix converter to the motor 105, and one or more temperature sensors 2425 configured to detect the temperature of the motor and/or the terminal box 160. The terminal box 160 may also have one or more ground terminals 2465. As describe above, distributing the electronic components of a variable frequency drive and/or matrix converter between the terminal box 160 and the end-plate 140 allows the motor assembly size (e.g., the inline length) to remain compact and within applicable guidelines, while providing energy efficiency, adjustable operating speed and torque, and/or a lower starting current. It should be noted that the variable frequency drive may be configured to provide power to the electric motor.

With continued reference to FIG. 24A, the terminal box 160 may have a radio frequency interference (RFI) filter 2408 covered by a steel shield 2415, busbars, and/or an application control board 2410. The application control board 2410 may allow a user to control and monitor the motor 105 by connecting external hardware (e.g., computers, controllers, and/or sensors) to the application control board 2410. In some embodiments, the external hardware devices may communicate with the application control board 2410 through wireless signals such as Bluetooth or cellular radio. Alternatively, or in addition, the user may connect wires to the application control board 2410 to establish a physical link between the external hardware devices and the application control board 2410. For example, a user may connect one or more external hardware devices into the connectors 1010. The connector 1010 may be physically connected (e.g., via one or more wires) to the application control board 2410, the multi-board power plane 200, and/or any other component of the matrix converter. The application control board 2410 can also be connected to the matrix converter, including one or more processors or other components of the matrix converter within the end-plate 140, thereby allowing for control of or programming of the matrix converter by the application control board 2410.

In some embodiments, the application control board 2410 may be connected to a secondary control board 2470. The secondary control board 2470 may span from the first electronic compartment 1005 to the second electronic compartment 2300. Thus, the secondary control board 2470 may enable the transmission of both information and power between the two electronic compartments 1005, 2300.

FIG. 24B shows a top view of a portion of the terminal box 160 with the lid 2401 removed, thereby exposing the three input filter inductors 2400A, 2400B, 2400C. As described above, the three input filter inductors 2400A, 2400B, 2400C may correspond to the inductors 3111, 3112, 3113 of the input filter 3101 of FIG. 31 and/or the inductors of the input filter 3501 of FIG. 35. FIG. 24B also shows the terminal box 160 with the steel shield 2415 removed, thereby exposing components of the RFI filter 2408, which can include one or more surge protection varistors 2435 (e.g., metal-oxide varistors [MOVs]) configured to protect against grid voltage surges, one or capacitors, and one or more inductors (e.g., a toroid inductor).

FIG. 24C depicts another view of the terminal box 160 with certain wiring connections shown, which were not shown in FIG. 24A or FIG. 24B for the purposes of simplicity. For example, FIG. 24C shows a first set of wires 2445 connecting grid power to the input power terminal block 2440. In some embodiments, the first set of wires 2445 are routed through the protective conduit 2330 from the third electronic compartment 2310. The third electronic compartment 2310 may be connected to grid power via one or more connectors 2475. The first set of wires 2445 may include a ground wire 2446.

In some embodiments, the terminal box 160 includes a second set of wires 2450 extending from outputs of the input filter inductors 2400A, 2400B, 2400C through the opening 547 of the terminal box 160 to corresponding connection points 505 in the wiring terminal 500 of the end-plate 140 (FIG. 5B), and thereby to provide input power to the downstream components of the matrix converter residing in the end-plate 140. The terminal box 160 may also, or alternatively, include a third set of wires 2455 extending from an output of the matrix converter in the end-plate 140, via corresponding connection points 505 in the wiring terminal 500 of the end-plate 140, through the opening 547 in the terminal box 160, thereby providing AC-AC converted power signals from the matrix converter to an input of the output motor power terminal block 2420. In this fashion, the second set of wires 2450 and/or third set of wires 2455 may be routed from the second electronic compartment 2300 to the end-plate 140 via the wiring terminal 500. For example, one or more wires from the second set of wires 2450 and/or third set of wires 2455 may correspond to cable 1020 and/or power cable 1025, as shown in FIGS. 9 and 10B. In the illustrated embodiment, a fourth set of wires 2460 extends from an output of the output motor power terminal block 2420 through the opening 2405 in the bottom of the terminal box 160, to the motor 105, thereby delivering AC-AC converted power signals from the matrix converter to the motor 105.

### Additional Example End-plates

In certain use cases, heat can be a significant problem that can shorten the life of a motor and associated control components. For example, many drilling and pumping operations are performed in locations with limited cooling. Moreover, even when operating in locations with significant cooling infrastructure, the demands on the motor can create significant heat. Accordingly, it is desirable to design the motor driver and supporting infrastructure in a manner that reduces heat buildup and that can cool heat generating components as efficiently and quickly as possible. To that end, the present disclosure describes certain example embodiments of an end-plate (e.g., end-plate 140) that reduces heat buildup. Moreover, embodiments are disclosed herein that facilitate cooling various heat generating components of a motor assembly (e.g., motor assembly 100) and/or generate relatively high horsepower.

Advantageously, in certain embodiments, the improved heat reduction and cooling techniques associated with the design disclosed herein enable support for scaling the motor to generate higher horsepower. For instance, embodiments are also disclosed that include embedded or integrated drive electronics units configured to accommodate a larger number of switching components or other drive electronics within a drive electronics housing. In certain embodiments, the motor assembly 100 can include an integrated drive electronics unit configured for mounting in-line with the motor while accommodating a relatively large number of switching components in a compact form factor, and supporting horsepower of between 25 HP and 200 HP. In some embodiments, greater horsepower may be supported, such as up to 500 HP, or more.

Relocating at least some of the heat generating electronic components of the motor drive, e.g., away from other components of the motor drive and/or motor can help to reduce the impact of heat. For example, moving the power modules 1205 in an intelligent manner can reduce the impact of heat from the power modules 1205 on additional components, such as the input filter capacitors 1305 and clamp capacitors 1310, among others.

According to certain aspects, mounting the switching components or other electronics components to a peripheral wall, or proximate to a peripheral wall, can provide more efficient heat loss and/or space utilization.

FIG. 25A is a front view of an example of an end-plate 2500 with circumferentially distributed matrix converter circuit elements 2504 in accordance with certain embodiments. The end-plate 2500 can include one or more of the aspects described with respect to the end-plate 140. The end-plate 2500 can include a back wall 2508 and a side wall 2502. It should be understood that the term back wall is a matter of convention and not indicated to be limiting. In some cases, the back wall 2508 can be the wall of the end-plate 2500 that is further from the motor 105 and closer to the fan 145. However, in some cases, the back wall 2508 may be closer to the motor 105 and farther from the fan 145. Further, in some cases, the back wall 2508 may be a front wall. The back wall 2508 may be orthogonal to the side wall 2502. Alternatively, the angle between the back wall 2508 and the side wall 2502 may be more or less than 90°.

The back wall 2508 and the side wall 2502 can form a space envelope or a cavity that supports the positioning of matrix converter circuit elements within the end-plate 2500. As illustrated in FIG. 25A, the side wall 2502 may include a degree of thickness that can separate the elements 2504 from the heatsink or cooling fins 2506. The thickness of the side wall 2502 may vary based on the embodiment. In some cases, the side wall 2502 may be relatively thin being only large enough to provide sufficient structure and support for the elements 2504. In other implementations, as will be described in more detail below, the side wall 2502 may be thicker to enable the inclusion of a hollow space between an interior of the side wall 2502 and an exterior of the side wall 2502. This hollow space between the exterior wall and the interior wall of the side wall 2502 may, in some embodiments, be used to facilitate cooling of the elements 2504. Further, the back wall 2508 may also be hollow to facilitate cooling of the interior cavity of the end-plate 2500 that houses the variable frequency drive electronics including, for example, the elements 2504 (which may, for example, be power modules). The fins 2506 may include one or more of the embodiments described with respect to the radial cooling fins 405 and/or the peripheral cooling fins 410.

Although not illustrated, in certain embodiments the back wall 2508 may include an opening (e.g., similar to the opening 415 of FIG. 4) enabling a non-drive end of the rotor 115 to pass through the end-plate 2500. Advantageously, as has been described herein and illustrated with respect to the end-plate 140, the rotor 115 may be used to turn a fan 145 that may be positioned subsequent to the end-plate 2500. In other embodiments, the back wall 2508 may not include an opening. In such embodiments, the fan 145 may be rotated using other means and/or may be omitted. In some such cases, alternative cooling systems may be implemented as described herein.

The elements 2504 may be matrix converter circuit elements or elements used to implement a matrix converter of a variable frequency drive. In some cases, the elements 2504 may be power modules (e.g., the power modules 1205). Thes power modules may comprise packaged integrated circuits including bidirectional power switches. As illustrated in FIG. 25A-25B, there may be 18 power modules, which can form a two-level matrix converter. In other embodiments, there can be fewer more elements 2504. For example, there may be nine power modules that form a single-level 3×3 matrix converter. In various other embodiments, a multi-level matrix converter includes 27, 36, or 72 or more bi-directional switches. In some cases, the elements 2504 include capacitors, such as the input filter capacitors 1305 and/or the clamp capacitors 1310. In yet other embodiments, the elements 2504 may be a combination of power modules and capacitors.

FIG. 25B is a front perspective view of the end-plate of FIG. 25A in accordance with certain embodiments. As illustrated in FIG. 25B, the fins 2506 can extend along the width of the outside of the end-plate 2500. In other implementations, the fins 2506 may be smaller or larger than the width of the end-plate 2500. Further, although not visible in FIG. 25B, additional heatsinks or heatsink fins may exist on the back side of the end-plate 2500. These additional heatsink fins may face a fan that can be configured to blow air across the heatsink fins.

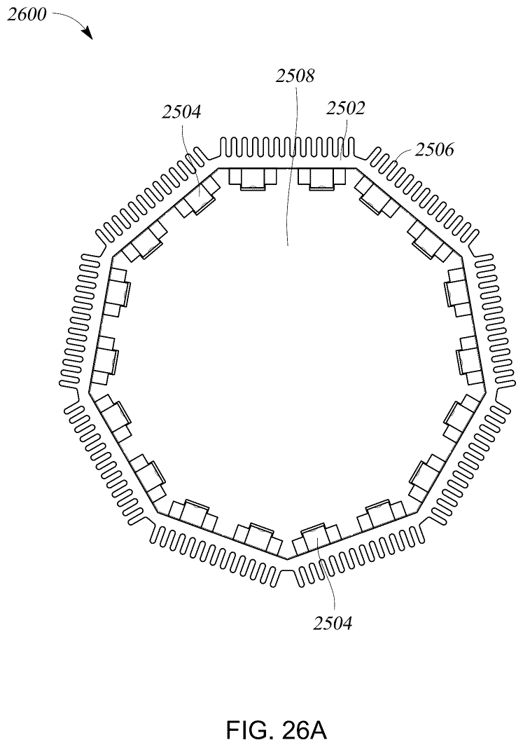

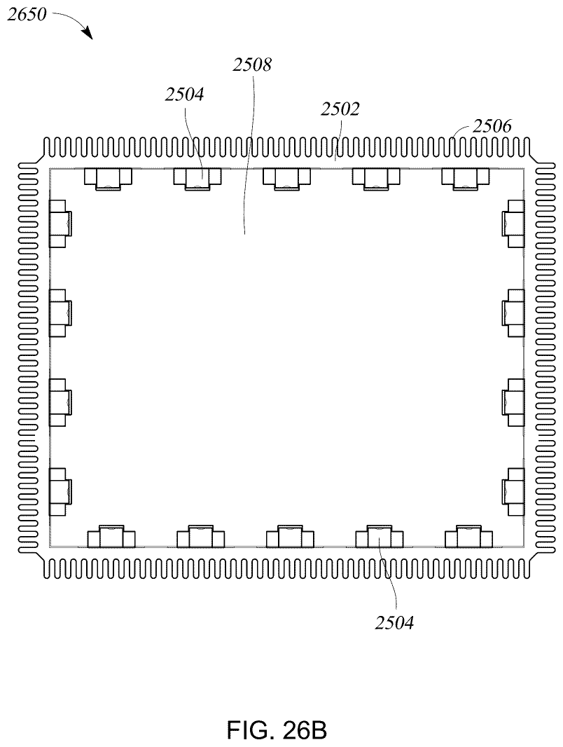

FIGS. 25A and 25B illustrate the end-plate 2500 as being circular in shape. It should be understood that other configurations of the end-plate 2500 are possible. For example, the end-plate 2500 may be shaped as an oval. Advantageously, shaping the end-plate 2500 using non-circular shapes may permit the motor assembly 100 to be positioned in locations that have space constraints. In some implementations, the end-plate 2500 can include any type of polygonal, regular, or irregular shape. Some non-limiting examples of the shapes for the end-plate are illustrated in FIG. 26A and FIG. 26B.

FIG. 26A is a front view of an example of a nine-sided or nonagonal end-plate 2600 with distributed matrix converter circuit elements 2504 in accordance with certain embodiments. The nonagonal end-plate 2600 can include two elements 2504 on each side within the nonagonal end-plate 2600 for a total of 18 elements 2504. In some cases, each of the elements 2504 within the nonagonal end-plate 2600 may be a power module. Further, the elements 2504 may be configured to form a multi-level matrix converter. For example, the elements 2504 may include 18 power modules forming a two-level matrix converter with 9 power modules in each level. In other cases, some of the elements 2504 may be power modules and other elements may be filters or capacitors. For example, each side of the nonagonal may have a power module and capacitor pair.

Each of the nine side walls 2502 may be orthogonal, or at a 90° angle, from the back wall 2508. Further, there may be a 40° angle between each of the side walls 2502.

FIG. 26B is a front view of an example of a rectangular end-plate 2650 with distributed matrix converter circuit elements 2504 in accordance with certain embodiments. In the illustrated embodiments, the rectangular end-plate 2650 includes four elements 2504 on the sides and five elements 2504 on the top and bottom of the rectangular end-plate 2650. It should be understood that the sides, top, and bottom are just for convention, and that the rectangular end-plate 2650 may be rotated such that there are five elements 2504 on the sides and four elements 2504 on the top and bottom of the rectangular end-plate 2650. Moreover, other distributions are possible within the scope of the present disclosure. For example, there may be nine elements 2504 along two opposite sides (e.g., the left and right or the top and bottom sides) and no elements along the other two sides. As another example, there may be six elements 2504 alone the pair of longer sides of the rectangular end-plate 2650, and three elements along the shorter sides of the rectangular end-plate 2650. In some cases, there may be six elements 2504 along three of the sides of the rectangular end-plate 2650 and no elements 2504 along the fourth side.

As previously described, the end-plate 2500 may include heatsink fins (e.g., the radial cooling fins 405) on the outside of the back wall 2508. These fins may be positioned to face a fan (e.g., the fan 145). Similarly, the nonagonal end-plate 2600 and the rectangular end-plate 2650 may also include heatsink fins that are positioned to face a fan 145. The fan 145 may blow air across the radial cooling fins 405 to facilitate cooling the electronics included within the end-plate 2500 (or the nonagonal end-plate 2600 or the rectangular end-plate 2650). To simplify discussion, much of the following disclosure refers to the end-plate 2500. However, it should be understood that discussion relating to the end-plate 2500 may equally be applicable to the nonagonal end-plate 2600 or the rectangular end-plate 2650, as well as other designs for the end-plate 2500.

In some cases, the end-plate 2500 may form an enclosure, alone or in combination with the conductive cover 220. For example, the end-plate 2500 may form a cavity that enables placement of the components of a variable frequency drive and/or matrix converter (e.g., formed from the elements 2504). The cavity may be sealed using the conductive cover 220, which may be formed from a thermally conductive material enabling heat generated by the enclosed electronic components to escape the enclosure formed by the end-plate 2500. Thus, the conductive cover 220 can be a thermal conductor that may be placed at an entrance to the cavity to prevent or reduce an occurrence of contaminants, such as dust from entering the cavity. Advantageously, the cavity or space within the end-plate 2500 may be sealed preventing dust or other particles from entering the cavity that houses the electronic components (e.g., the elements 2504).

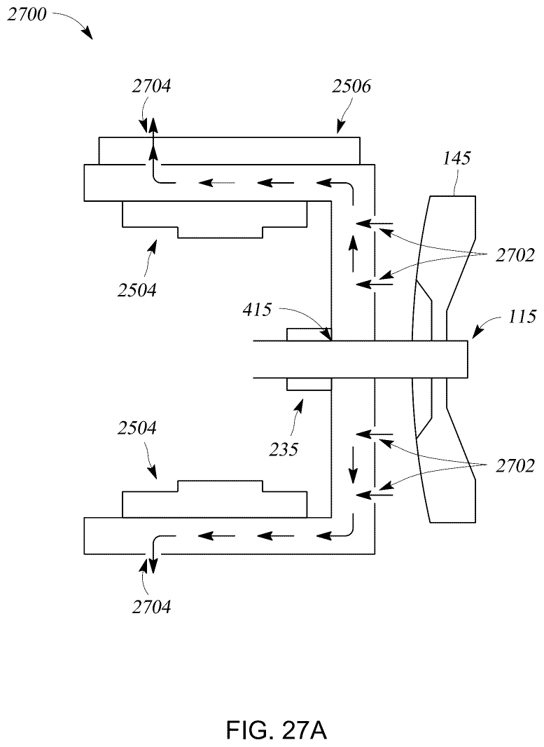

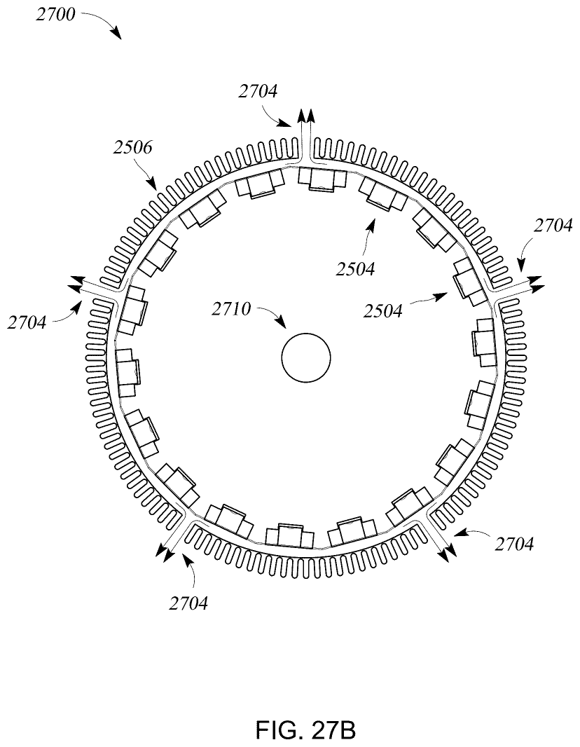

Further, in some cases, the side walls and/or back walls of the end-plate 2500 may have a thickness. This thickness may be sufficient for the side and/or back walls of the end-plate 2500 to form an internal space between the inner and outer walls of the end-plate 2500. In other words, as illustrated in FIG. 27A, the walls of the end-plate may be hollow.

FIG. 27A is a side view of an example of an end-plate 2700 that is hollow to permit air from a fan to flow through the hollow end-plate in accordance with certain embodiments. The end-plate 2700 may be an implementation of the end-plate 2500 and may include one or more of the embodiments previously described with respect to the end-plate 2500.

The end-plate 2700 may form an enclosure or a cavity that can house the elements 2504. As previously described, the elements 2504 may be affixed to the back wall of the end-plate 2700 or to the side walls of the end-plate 2700. Further, the elements may be affixed to a circuit board (not shown). Further, as described with respect to the end-plate 2500, the end-plate 2700 may be sealed to reduce or prevent dust or other particles or contaminants from entering the cavity that includes the elements 2504. However, there may be an opening 415 to permit the rotor 115 (e.g., the non drive-end of the rotor 115) to pass through the central column 235 and the end-plate 2700. The rotor 115 may be used to turn the fan 145, which may create an air flow across the back of the end-plate 2700. Further, the walls (back and sides) that form the end-plate 2700 may be hollow. The end-plate 2700 may include an interior wall that forms the cavity and can house, for example, the elements 2504. Further, the end-plate 2700 may include an exterior wall that at least partially surrounds the interior wall. This exterior wall may include the fins 2506 and a portion of the exterior wall may face the fan 145. A gap or spacing between the interior wall and the exterior wall may for them hollow space that can permit air flow from the fan 145 or, as described further below, liquid cooling piping.

The back wall may include ingress holes 2702 that permit air to flow into the hollow of the back wall of the end-plate 2700. The fan 145 may create an air flow that pushes air into the ingress holes 2702 and out of egress holes 2704. The flow of air through the hollow walls of the end-plate 2700 can help to cool the elements 2504 and other electronics (e.g., capacitors and filters) within the cavity formed by the end-plate 2700. The flow of air within the cavity can provide improved cooling compared to systems that flow air on the outside of the walls of the end-plate. Further, although not illustrated, the end-plate 2700 may include peripheral cooling fins 410 along the outside of the back wall of the end-plate 2700 similar to what has previously been illustrated with respect to the end-plate 140. Thus, the fan 145 may be used to both circulate air across the peripheral cooling fins 410 as well as through the hollow space between the inner and outer walls of the end-plate 2700. Further, the air that exits the end-plate 2700 via the egress holes 2704 may also blow across the fins 2506, which may help to further cool the electronics housed within the end-plate 2700.

In the example depicted in FIG. 27A, there are four ingress holes 2702 and two egress holes 2704 illustrated. There may be more or fewer ingress holes 2702 and/or egress holes 2704 than illustrated. Further, the number, the size, and the position of the ingress holes 2702 and/or egress holes 2704 may be selected based on a number of factors including the size of the motor 105, the size of the rotor 115, the amount of heat generated by the electronics included in the end-plate, the operating conditions of the motor 105, the operating environment of the motor 105, and the like.

FIG. 27B is a front view of the example end-plate 2700 of FIG. 27A in accordance with certain embodiments. As illustrated, the egress holes 2704 may be positioned around the circular structure of the end-plate 2700. As the ingress holes 2702 are positioned in the backwall of the end-plate 2700 facing towards the fan 145, the ingress holes 2702 are not visible within FIG. 27B. The end-plate 2700 may further include a hole or port 2710 to permit passage of the rotor 115, which may be used to turn or operate the fan 145. In some cases, the fan 145 may be operated by a separate motor from the motor 105 and/or by a separate power source. In such cases, the rotor 115 may not operate the or turn the fan 145. Further, in some such cases, the port 2710 may be optional or omitted.

In some embodiments, alternative or additional cooling systems may be implemented in place of or in addition to the fan 145. For example, the motor assembly 100 may include a liquid cooling system that can be used to cool electronics housed within the terminal box 160 and/or the end-plate 2500.

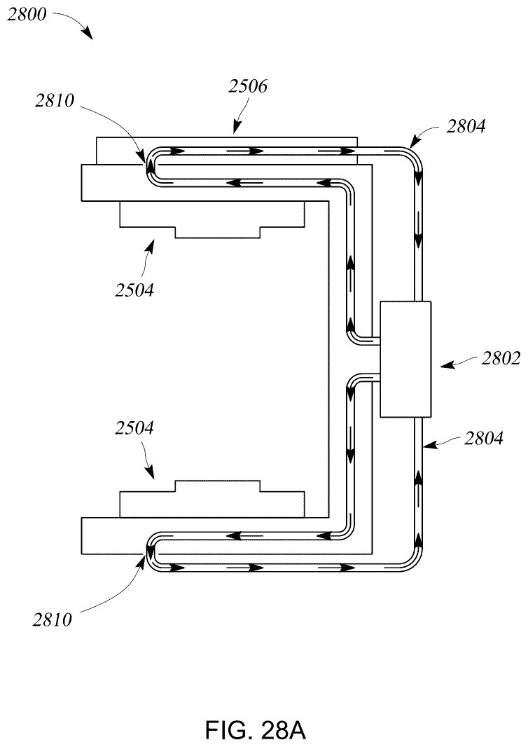

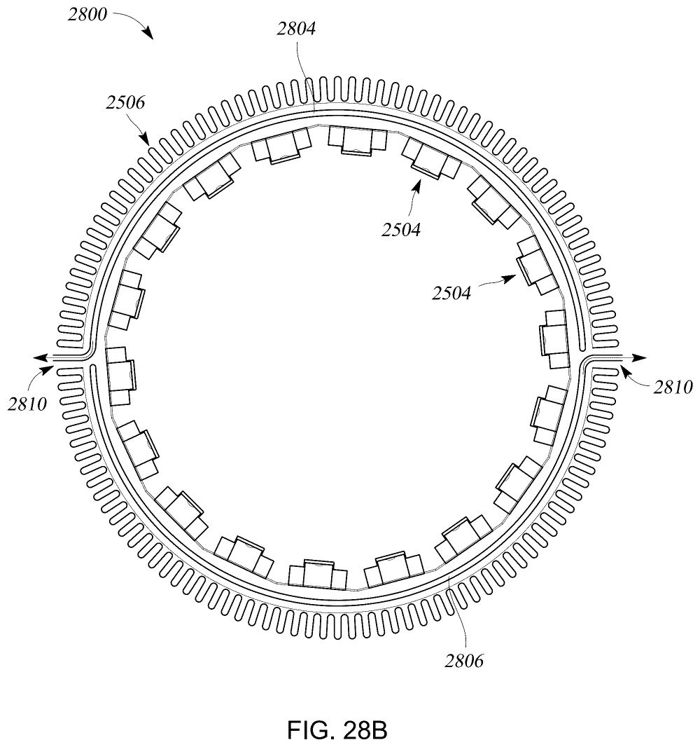

FIG. 28A is a side view of an example of an end-plate 2800 that includes a liquid cooling system in accordance with certain embodiments. The end-plate 2800 can include one or more of the embodiments previously disclosed with respect to the end-plate 140, the end-plate 2500, the end-plate 2700, or other end-plates disclosed herein. The liquid cooling system may include a coolant system 2802. This coolant system 2802 may include a pump or other mechanism for forcing or causing liquid coolant to flow out of a reservoir and through a pipe into a hollow space formed between an interior wall and an exterior wall of the end-plate 2800. As explained above with respect to the end-plate 2700, the end-plate 2800 may be formed from an interior wall and an exterior wall. A gap between these walls may provide space for piping that can be used to facilitate the distribution or transport of a coolant (e.g., a liquid coolant) behind the elements 2504 so as to remove heat generated by the elements 2504.

The coolant system 2802 may further include a reservoir that contains the liquid that is pumped through the piping for cooling the elements 2504. The reservoir may at least temporarily store the liquid coolant. For example, the liquid coolant may be in the reservoir and a pump of the coolant system 2802 may pump out the coolant liquid and cause the pumped liquid to flow through piping, which may circle back to the reservoir creating a closed system. The liquid may include any type of liquid that can absorb heat generated by the elements 2504 through the walls of the end-plate 2800. For example, the liquid may be water, ethylene glycol, oil, synthetic coolant, semi synthetic coolant, water and oil mixture coolants, or any other type of coolant.

The pump of the coolant system 2802 may cause liquid to flow through the outflow or egress pipes 2810 which may be distributed within the hollow space between the interior and exterior walls of the end-plate 2800. The flow of liquid through the outflow or egress pipes 2810 enables heat to be absorbed from the elements 2504 attached to the interior walls of the end-plate 2800. The heated liquid or coolant may then flow back to the reservoir of the coolant system 2802 via inflow or ingress pipes 2804. In some cases, the piping is made of a non-insulating material that permits heat to dissipate as liquid flows through the inflow or ingress pipes 2804 back to the reservoir of the coolant system 2802. Alternatively, or in addition, the coolant system 2802 may include a cooling mechanism to cool the liquid before it is pumped back through the outflow or egress pipes 2810. In some cases, the fan 145 may be positioned behind the coolant system 2802 and may flow air over the coolant system 2802 to help cool the liquid coolant. Thus, in some cases, the cooling system may be a combination of a liquid cooling system and a fan-based cooling system.

FIG. 28B is a front view of the example end-plate of FIG. 28A in accordance with certain embodiments. As illustrated, the elements 2504 may be positioned around the inner circumference of the end-plate 2800. The outer circumference may include fins 2506 around the outer walls of the end-plate 2800. Between the inner and outer circumference of the end-plate 2800 is a hollow space that can house the inflow or ingress pipes 2804 and/or the outflow or egress pipes 2810. The inflow or ingress pipes 2804 may come from behind the end-plate 2800 (from behind the drawing sheet towards the viewer). In some cases, the inflow or ingress pipes 2804 (or the outflow or egress pipes 2810) may wrap around the circumference of the end-plate 2800 until an egress point is reached. Upon reaching an opening in the outer circumference of the end-plate 2800, the outflow or egress pipes 2810 may exit the hollow space formed by the inner and outer circumference of the end-plate 2800. The outflow or egress pipes 2810 may then return to the coolant system 2802 as illustrated in FIG. 28A forming a closed loop. In some cases, the coolant system 2802 may have an opening or port that permits a user to add or replace coolant as may, in some cases, be needed over time.

In some embodiments, the liquid cooling system can be a closed loop passive cooling system. For example, the liquid cooling system may include a heat pipe. The heat pipe may transfer heat through the evaporation and condensation of a fluid (e.g., water, coolant, etc.) within a sealed container (e.g., a reservoir and/or pipes, such as inflow or ingress pipes 2804 and outflow or egress pipes 2810). In some such example, heat may be absorbed at one end of the heat pipe (e.g., the evaporator) causing the fluid to vaporize. The vaporized fluid may then travel as vapor to a cooler end (e.g., a condenser) where it may condense back into a liquid relating the absorbed heat, and may be returned to the evaporator, such as through a wick structure via capillary action. In some cases, the closed loop passive cooling system may allow for highly efficient heat transfer with little to no moving parts and can act like a thermal siphon that continuously cycles fluid between the two phases, liquid and vapor.

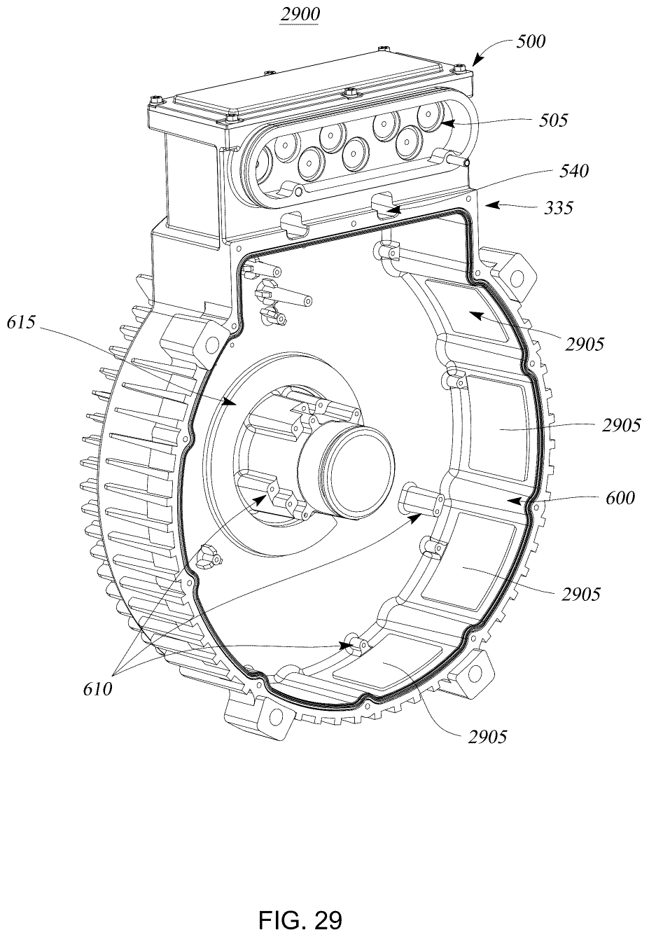

FIG. 29 is an example end-plate 2900 with terminal box connectors in accordance with certain embodiments. The end-plate 2900 may include one or more of the embodiments of the end-plate 2500 or other end-plates described herein. The end-plate 2900 may include a wiring terminal 500 that has terminal points 505 that enable connection to a terminal box (e.g., the terminal box 160). Further, the end-plate 2900 may include a set of mounting surfaces 2905 around the inner circumference of the sidewall of the end-plate 2900. The set of mounting surfaces 2905 may be used to mount power modules 1205, current sensing modules 1206, input filter capacitors 1305, clamp capacitors 1310, or any other circuit components (none of which are shown in FIG. 29) that may be used to implement a matrix converter or a variable frequency drive.

Advantageously, mounting the power modules 1205, or other heat producing circuit elements, on the set of mounting surfaces 2905 enables use of one or more of the improved cooling techniques described herein. For example, mounting the power modules 1205 on the set of mounting surfaces 2905 enables air flow generated by the rotor 115 to flow across the backside of the set of mounting surfaces 2905 within a hollow of the end-plate 2900 as illustrated with respect to the end-plate 2700 in FIG. 27A. Additionally, or alternatively, liquid cooling can be used as illustrated with respect to the end-plate 2800 in FIG. 28A. Further, distributing the set of mounting surfaces 2905 along the side wall of the end-plate 2900 enables the power modules 1205 to be distributed over a larger area compared to embodiments where the power modules 1205 are exclusively mounted parallel to the back wall of the end-plate. Distributing power modules 1205 over a larger area can reduce the heat within the end-plate 2900 by distributing heat over a larger area while also improving the ability to cool the end-plate 2900 by providing for a larger surface area over which to implement cooling.

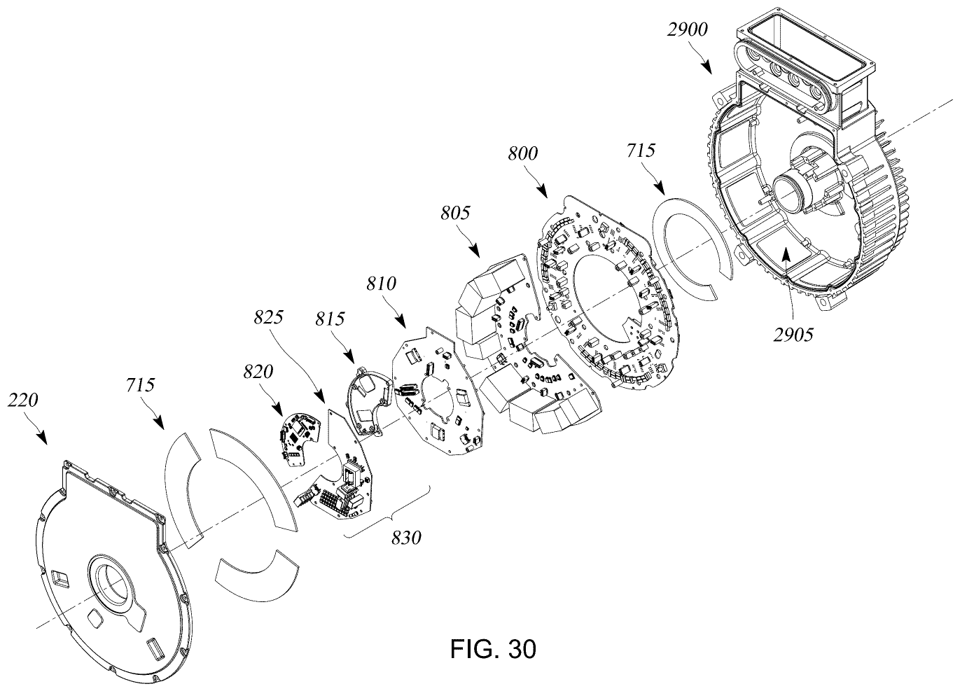

FIG. 30 is an exploded view of the end-plate 2900 and certain internal components in accordance with certain embodiments. Depending on the embodiment, some or all of the power modules 1205 may be positioned to be distributed around the inner circumference of the sidewall(s) (or radial wall(s)) of the end-plate 2900. In some such embodiments, the mounting surfaces 2905 may be distributed around the inner circumference of the sidewall(s) or radial wall(s) of the end-plate 2900 to facilitate mounting of the power modules 1205 to the sidewall(s). The power modules 1205 may be mounted to the mounting surfaces 2905 along the sidewalls or radial walls of the end-plate 2900. In such cases, the mounting surface 2905 can include contacts and/or one or more printed circuit boards adhered thereto for establishing electrical contact (e.g., via soldering) with corresponding pins or other contacts of the power modules 1205. In this fashion, the sidewall can include appropriate electrical traces, contacts, etc., for establishing electrical connectivity between the power modules 1205 and other drive electronics, such as the electronics on any of the power layer 800, the control layer 805, the second control layer 810, and the third control layer 830. In one implementation a bendable printed circuit board conforms to the shape of the sidewall and extends along some or all of the sidewall, and the power modules 1205 are mounted on the printed circuit board.

As with the mounting surfaces 605 of the end plate 140 of FIG. 6, the set of mounting surfaces 2905 may be formed from heat or thermal conductive materials that may facilitate heat transfer from the power modules 1205 for cooling. In some such cases, instead of being mounted to the mounting surfaces 2905 for making electrical connection, the top of the power modules 1205 contact corresponding surfaces 2905 to facilitate improved heat transfer from the power modules 1205 to the surfaces 2905. For example, the power modules 1205 may be mounted and electrically connected to one or more printed circuit boards fastened to or otherwise supported proximate the sidewall of the end plate 2900, such that the power modules 1205 are sandwiched between the printed circuit boards and the surfaces 2905 of the end plate 2900.

Comparing FIG. 30 with FIG. 8, the internal components positioned within the end-plate 2900 may be the same as those positioned within the end-plate 140. Within the end-plate 140, some the power modules 1205 within the end plate 2900 may additionally be mounted to the backside of the circuit board of the power layer 800 as illustrated in FIG. 12. As such, some of the power modules 1205 may be positioned or sandwiched between the power layer 800 and the back wall of the end-plate 2900, and parallel to the back wall of the end-plate 2900, in addition to others the power modules 1205 being mounted to the sidewall(s) of the end plate 2900. Thus, in such cases, while not shown in FIG. 30, at least some of these power modules 1205 may be in contact with contact surfaces within the inner surface of the back wall of the end-plate 140, like the contact surface 605 of FIG. 6, for example. Alternatively, or in addition, at least some of the power modules 1205 may be mounted directly to the back wall of the end-plate 140, instead of to the power layer 800. In such cases, the back wall of the end plate may have a circuit board adhered thereto or otherwise be adapted to make electrical contact with the power modules 1205. In certain embodiments, the mounting surfaces 605 are formed from heat conductive materials that facilitate transferring of heat from the power modules 1205 to the surface of the end-plate 140, thereby enabling the cooling systems of the motor assembly 100 (e.g., the fan 145, the heatsink radial cooling fins 405, and/or the coolant system 2802) to remove or reduce heat within the electronic drive system or the variable frequency drive of the motor assembly 100. In some cases, one or more of the back wall and/or the side wall of the end-plate 2900 may be made of an electrically and/or thermally conductive material.

Thus, the power modules 1205 and/or other heat generating circuit elements can be distributed among the sidewall(s) of the end-plate 2900 and the back wall of the end-plate 2900, such that some of the power modules 1205 are located on, supported by, or mounted proximate to the side wall and others of the power module 1205 are mounted parallel to, on, or supported by, the back wall. In other words, embodiments illustrated with the respect to the end-plate 2900 illustrated in FIG. 29 can be combined with embodiments illustrated with respect to, for example, the end-plate 140 illustrated in FIG. 8 and elsewhere herein. In one such implementation, there are nine power modules circumferentially distributed on a circuit board that resides in the end plate 2900, mounted parallel to the back wall of the end plate 2900 (e.g., similar to the power modules 1205 of the power layer 800 of FIG. 12), and nine power modules distributed about the side wall of the end plate 2900, mounted to the mounting surfaces 2905, and the 18 total power modules form a two-level matrix converter.

One drawback of conventional electric motors is that they are run at a fixed speed based on the input frequency of the AC power supply, and control of the rotational speed of a pump or other rotary device coupled to the electric motor is provided via mechanical structure (e.g., a brake, throttle valve), resulting in a waste of energy. Another drawback of existing electric motors is that the maximum speed of the electric motor is limited to the AC power supply's input frequency, thereby requiring a larger pump to be installed when increased pressure or flow of the pump is desired.

A matrix converter is a type of motor drive circuit that can adjust motor input frequency and voltage to control AC motor speed and torque as desired. For example, variable speed operation of an electric motor can improve reliability and throughput while reducing energy consumption. As discussed, the embodiments disclosed herein can include a matrix converter. For example, any of the embodiments discussed herein can include the matrix converters shown and described with respect to FIGS. 31-35, or any of the matrix converters described herein.

A matrix converter receives a multi-phase AC input voltage and opens and closes switches of a switch array over time to thereby synthesize a multi-phase AC output voltage with desired frequency and phase. Various circuits are used in a matrix converter for control functions. For instance, a processor and/or field programmable gate array (FPGA) can be used for computations related to a modulation algorithm that selects which particular switches of the array are opened or closed at a given moment, and switch drivers can be included to provide DC control signals to the control inputs of the switches.

The matrix converter can also include a clamp circuit that dissipates load energy (for instance, overvoltage conditions arising during shutdown) by clamping one or more inputs terminal of the matrix converter to one or more output terminals of the matrix converter. Including the clamp circuit enhances robustness, for instance, by providing a discharge path for excess load current and/or to handle overcurrent and shutdown conditions.

In certain embodiments herein, a matrix converter includes an array of switches having AC inputs that receives a multi-phase AC input voltage and AC outputs that provide a multi-phase AC output voltage to a load. The matrix converter further includes control circuitry that opens or closes individual switches of the array, and a clamp circuit connected between the AC inputs and AC outputs of the array and operable to dissipate energy of the load in response to an overvoltage condition. The clamp circuit includes a switched mode power supply operable to generate a DC supply voltage for the control circuitry.

Implementing the matrix converter in this manner provides a number of advantages, including an ability to maintain the control circuitry on for a longer duration of time when the AC input power is lost or of poor quality.

FIG. 31 is a schematic diagram of a matrix converter 3130 according to one embodiment. The matrix converter 3130 includes an input filter 3101, an array of switches 3102, a clamp circuit 3103, control circuitry 3104, 3-phase AC input terminals 3105, and 3-phase AC output terminals 3106.

In the illustrated embodiment, the input filter 3101 is implemented as an inductor-capacitor (LC) filter that serves to filter a 3-phase AC input voltage received on the 3-phase AC input terminals 3105 to generate a filtered 3-phase AC input voltage for the array of switches 3102. The input filter 3101 can also filter out switched noise caused by the array of switches 3102 and prevent such noise from contaminating the AC supply. The input filter 3101 can be a low pass filter. The 3-phase AC input voltage can correspond to, for example, three AC input voltage waveforms received from a power grid and each having a phase separation of about 120° and a desired voltage amplitude (for instance, 240 V or other desired voltage).

As shown in FIG. 31, the input filter 3101 includes a first inductor 3111 connected between a first AC input terminal and a first AC input to the array of switches 3102, a second inductor 3112 connected between a second AC input terminal and a second AC input to the array of switches 3102, and a third inductor 3113 connected between a third AC input terminal and a third AC input to the array of switches 3102. The input filter 3101 further includes a first capacitor 3115 electrically connected between the first AC input and the second AC input of the array of switches 3102, a second capacitor 3116 electrically connected between the second AC input and the third AC input of the array of switches 3102, and a third capacitor 3117 electrically connected between the first AC input and the third AC input of the array of switches 3102.

Including the input filter 3101 provides a number of advantages, such as providing protection against pre-charge and/or inrush current during power-up. Although one implementation of an input filter is depicted, matrix converters can be implemented with input filters of a wide variety of types. Accordingly, other implementations are possible.

The control circuitry 3104 opens or closes individual switches of the array of switches 3102 over time to thereby provide a 3-phase AC output voltage to the 3-phase AC output terminals 3106 with a desired frequency and phase relative to the 3-phase AC input voltage. The control circuitry 3104 can include various circuits for control functions. In a first example, the control circuitry 3104 can include a processor and/or FPGA for computations related to a modulation algorithm used to select which particular switches of the array of switches 3102 are opened or closed at a given moment. In a second example, the control circuitry 3104 can include switch drivers that provide DC control signals to the switches of the array of switches 3102 to thereby open or close the switches as desired.

The clamp circuit 3103 is electrically connected between the AC inputs and AC outputs of the array of switches 3102, and operates to dissipate energy during shutdown of the matrix converter 3130 or other overvoltage conditions. For example, the discharge activation circuit 3144 can sense a high voltage condition, and triggering the semiconductor switch 3143 to send cause overvoltage energy to pass through the clamp resistor 3141, thereby converting energy into thermal energy dissipated as heat. Including the clamp circuit 3103 enhances robustness, for instance, by providing a discharge path for excess load current and/or to handle overcurrent and shutdown conditions. For example, the clamp circuit 3103 can prevent freewheel paths for load current during shutdown and/or current paths for over-current.

In the illustrated embodiment, the clamp circuit 3103 includes a switched mode power supply 3120 that serves to generate DC power for the control circuitry 3104. In certain implementations, the supply voltage input to the switched mode power supply 3120 is directly connected to at least one internal node of the clamp circuit 3103. For example, a first internal node of the clamp circuit 3103 can serve to provide an input voltage to the switched mode power supply 3120 while a second internal node of the clamp circuit 3103 can serve as a ground voltage to the switched mode power supply 3120.

A switched mode power supply is an electronic power supply that incorporates a switching regulator to convert electrical power efficiently. For example, a switched mode power supply can convert power using switching devices that are turned on and off at high frequencies, and storage components such as inductors or capacitors to supply power when the switching device is in a non-conductive state.

Providing the input voltage to the switched mode power supply 3120 from a node of the clamp circuit 3103 provides a number of advantages, including an ability to maintain the control circuitry 3104 on for a longer duration of time when the AC input power is lost or of poor quality.

FIG. 32 is a schematic diagram of one embodiment of a clamp circuit 3170 for a matrix converter. The clamp circuit 3170 includes a switched mode power supply 3120, a first input clamping diode 3131, a second input clamping diode 3132, a third input clamping diode 3133, a fourth input clamping diode 3134, a fifth input clamping diode 3135, a sixth input clamping diode 3136, a clamp capacitor 3138, a clamp resistor 3141, a clamp diode 3142, an insulated gate bipolar transistor (IGBT) 3143, a discharge activation circuit 3144, a first output clamping diode 3151, a second output clamping diode 3152, a third output clamping diode 3153, a fourth output clamping diode 3154, a fifth output clamping diode 3155, and a sixth output clamping diode 3156.

Although one embodiment of a clamp circuit for a matrix converter is depicted, the teachings herein are applicable to clamp circuits implemented in a wide variety of ways. Accordingly, other implementations are possible.

The clamp circuit 3170 includes a first group of terminals 1061-1063 that connect to the AC inputs of an array of switches, and a second group of terminals 1064-1066 that connect to the AC outputs of the array of switches. The first group of terminals 1061-1063 includes a first terminal 3161, a second terminal 3162, and a third terminal 3163. Additionally, the second group of terminals 1064-1066 includes a fourth terminal 3164, a fifth terminal 3165, and a sixth terminal 3166.

As shown in FIG. 32, the input clamping diodes 1031-1036 serve as an input diode array connecting the first discharge node 3157 and the second discharge node 3158 to the AC inputs 1061-1063, while the output clamping diodes 1051-1056 serve as an output diode array connecting the first discharge node 3157 and the second discharge node 3158 to the AC outputs 1064-1066.

In the illustrated embodiment, the first input clamping diode 3131, the second input clamping diode 3132, and the third input clamping diode 3133 include anodes electrically connected to the first terminal 3161, the second terminal 3162, and the third terminal 3163, respectively. Additionally, each of the first input clamping diode 3131, the second input clamping diode 3132, and the third input clamping diode 3133 includes a cathode electrically connected to the first discharge node 3157. Furthermore, the fourth input clamping diode 3134, the fifth input clamping diode 3135, and the sixth input clamping diode 3136 include cathodes electrically connected to the first terminal 3161, the second terminal 3162, and the third terminal 3163, respectively. Additionally, each of the fourth input clamping diode 3134, the fifth input clamping diode 3135, and the sixth input clamping diode 3136 includes an anode electrically connected to the second discharge node 3158. Furthermore, the clamp capacitor 3138 is electrically connected between the first discharge node 3157 and the second discharge node 3158.

With continuing reference to FIG. 32, the clamp resistor 3141 is electrically connected in series with the IGBT 3143 in a discharge path between the first discharge node 3157 and the second discharge node 3158. Although the IGBT 3143 illustrates one example of a discharge device, other implementations of discharge devices can be used.

The clamp resistor 3141 can be implemented in a wide variety of ways. For example, implementing the clamp resistor 3141 with low inductance can inhibits large voltages from developing across the clamp resistor 3141 during clamping.

In the illustrated embodiment, the gate of the IGBT 3143 is controlled by the discharge activation circuit 3144. In certain implementations, the discharge activation circuit 3144 selectively turns on the IGBT 3143 based on monitoring a voltage difference between the first discharge node 3157 and the second discharge node 3158. For example, the discharge activation circuit 3144 can activate the IGBT 3143 when the voltage difference between the first discharge node 3157 and the second discharge node 3158 indicates an overvoltage condition. In certain implementations, the discharge activation circuit 3144 provides the control circuitry with an overvoltage sensing signal indicating whether or not overvoltage has been detected.

As shown in FIG. 32, the clamp diode 3142 is connected in parallel with the clamp resistor 3141, with an anode of the clamp diode 3142 electrically connected to an intermediate node 3159 along the discharge path. Additionally, the cathode of the clamp diode 3142 is electrically connected to first discharge node 3157. The clamp diode 3142 serves as a freewheeling path for any inductive voltage spike generated by the rapid switching of the IGBT 3143 (or other semiconductor discharge device) into a parasitic inductance of the clamp resistor 3141.

In the illustrated embodiment, the switched mode power supply 3120 receives an input supply voltage corresponding to a voltage difference between the first discharge node 3157 and the second discharge node 3158, and generates a regulated DC output voltage that powers control circuitry of a matrix converter. For example, the second discharge node 3158 can serve as a ground voltage to the switched mode power supply 3120, while the first discharge node 3157 can serve as the input supply voltage to switched mode power supply 3120. In certain implementations, the switched mode power supply 3120 is operable over a voltage range of at least 250 V DC to 1000 V DC, thereby enhancing performance in the presence of fluctuations in voltage of the first discharge node 3157 and/or the second discharge node 3158.

As shown in FIG. 32, the first output clamping diode 3151, the second output clamping diode 3152, and the third output clamping diode 3153 include anodes electrically connected to the fourth terminal 3164, the fifth terminal 3165, and the sixth terminal 3166, respectively. Additionally, each of the first output clamping diode 3151, the second output clamping diode 3152, and the third output clamping diode 3153 includes a cathode electrically connected to the first discharge node 3157. Furthermore, the fourth output clamping diode 3154, the fifth output clamping diode 3155, and the sixth output clamping diode 3156 include cathodes electrically connected to the fourth terminal 3164, the fifth terminal 3165, and the sixth terminal 3166, respectively. Additionally, each of the fourth output clamping diode 3154, the fifth output clamping diode 3155, and the sixth output clamping diode 3156 includes an anode electrically connected to the second discharge node 3158.

FIG. 33 is a schematic diagram of one embodiment of a portion of circuitry 3300 of a matrix converter. The circuitry 3300 includes an array of switches 3302, switch drivers 1106a-1106i that drive bidirectional switches 1107a-1107i of the array of switches 3302, a control circuit 3304 that generates input control signals to the switch drivers 1106a-1106i, isolated DC-to-DC converters 1105a-1105i that power the switch drivers 1106a-1106i, and a switched mode power supply 3120 that powers the control circuit 3304 and the isolated DC-to-DC converters 1105a-1105i.

As shown in FIG. 33, the array of switches 3302 includes a first bidirectional switch 3307a connected between a first AC input 3321 and a first AC output 3324, a second bidirectional switch 3307b connected between the first AC input 3321 and a second AC output 3325, a third bidirectional switch 3307c connected between the first AC input 3321 and a third AC output 3326, a fourth bidirectional switch 3307d connected between the second AC input 3322 and the first AC output 3324, a fifth bidirectional switch 3307e connected between the second AC input 3322 and the second AC output 3325, a sixth bidirectional switch 3307f connected between the second AC input 3322 and the third AC output 3326, a seventh bidirectional switch 3307g connected between the third AC input 3323 and the first AC output 3324, an eighth bidirectional switch 3307h connected between the third AC input 3323 and the second AC output 3325, and a ninth bidirectional switch 3307i connected between the third AC input 3323 and the third AC output 3326.

The bidirectional switches 1107a-1107i serve to conduct both positive and negative currents, and are implemented to be able to block both positive and negative voltages.

As shown in FIG. 33, each of the bidirectional switches 1107a-1107i receive a pair of switch control signals. In particular, the bidirectional switches 1107a-1107i receive first to ninth pairs of switch control signals from switch drivers 1106a-1106i, respectively. The switch drivers 1106a-1106i receive first to ninth pairs of input signals from the control circuit 3304. By controlling the state of the input signals over time, the control circuit 3304 achieves a desired modulation algorithm, such as Venturini modulation, Alesina modulation, scalar modulation, fictitious DC-link modulation, and/or space vector modulator. Furthermore, the control circuit 3304 generates the input signals to provide current commutation and/or other desired switching properties.

In the illustrated embodiment, the switched mode power supply 3120 receives an input voltage from internal node(s) of a clamp circuit (not shown in FIG. 33) and generates a DC voltage that powers the control circuit 3304. Additionally, the DC voltage serves as an input to the isolated DC-to-DC converters 1105a-1105i, respectively. The isolated DC-to-DC converters 1105a-1105i in turn provide first to ninth DC voltages to the switch drivers 1106a-1106i, respectively. The isolated DC-to-DC converters 1105a-1105i can be implemented in a wide variety of ways, including, but not limited to, as flyback converters.

While FIG. 33 shows circuitry of a matrix converter including nine bi-directional switches 3307a-3307i, in other embodiments, matrix converters can be provided including more bi-directional switches. For example, a multi-level matrix converter can include 18 or more bi-directional switches, as described previously (e.g., 18, 27, 36, or 72 or more bi-directional switches).

FIGS. 34A-34C illustrate various embodiments of bidirectional switches for an array of switches of a matrix converter. Although various examples of bidirectional switches are shown, the teachings herein are applicable to bidirectional switches implemented in a wide variety of ways.

FIG. 34A is a schematic diagram of a bidirectional switch 3400 according to one embodiment. The bidirectional switch 3400 includes a first IGBT 3401, a second IGB2 1602, a first diode 3403, and a second diode 3404. The bidirectional switch 3400 is arranged in a common emitter back-to-back IGBT configuration.

As shown in FIG. 34A, the gate of the first IGBT 3401 receives a first control signal CTL1, and the gate of the second IGBT 3402 receives a second control signal CTL2. Additionally, the collector of the first IGBT 3401 is electrically connected to an input terminal IN and to a cathode of the first diode 3403, and the emitter of the first IGBT 3401 is electrically connected to the emitter of the second IGBT 3402 and to the anodes of the first diode 3403 and the second diode 3404. Furthermore, the collector of the second IGBT 3402 is electrically connected to an output terminal OUT and to a cathode of the second diode 3404.

FIG. 34B is a schematic diagram of a bidirectional switch 3420 according to another embodiment. The bidirectional switch 3420 includes a first IGBT 3421, a second IGBT 3422, a first diode 3423, and a second diode 3424. The bidirectional switch 3420 is arranged in a common collector back-to-back IGBT configuration.

As shown in FIG. 34B, the gate of the first IGBT 3421 receives a first control signal CTL1, and the gate of the second IGBT 3422 receives a second control signal CTL2. Additionally, the emitter of the first IGBT 3421 is electrically connected to an input terminal IN and to an anode of the first diode 3423, and the collector of the first IGBT 3421 is electrically connected to the collector of the second IGBT 3422 and to the cathodes of the first diode 3423 and the second diode 3424. Furthermore, the emitter of the second IGBT 3422 is electrically connected to an output terminal OUT and to an anode of the second diode 3424.

FIG. 34C is a schematic diagram of a bidirectional switch 3440 according to another embodiment. The bidirectional switch 3440 includes a first bidirectional IGBT 3441 and a second bidirectional IGBT 3442. The bidirectional switch 3440 is arranged in a reverse blocking IGBT configuration.

As shown in FIG. 34C, the gate of the first bidirectional IGBT 3441 receives a first control signal CTL1, and the gate of the second bidirectional IGBT 3442 receives a second control signal CTL2. Additionally, a collector/emitter of the first bidirectional IGBT 3441 is electrically connected to the input terminal IN and to the emitter/collector of the second bidirectional IGBT 3442, and an emitter/collector of the first bidirectional IGBT 3441 is electrically connected to the output terminal OUT and to the collector/emitter of the second bidirectional IGBT 3442. Thus, the first bidirectional IGBT 3441 and the second bidirectional IGBT 3442 serves as a pair of switching devices arranged in anti-parallel.

With respect to FIGS. 34A-34C, the first control signal CTL1 and the second control signal CTL2 are provided by a switch driver. Additionally, the input terminal IN couples to an AC input of a switch array, while the output terminal OUT couples to an AC output of a switch array.

FIG. 35 is a schematic diagram of a matrix converter 3500 according to another embodiment. The matrix converter 3500 is providing power to a motor 3518, and includes an input filter 3501, an array of switches 3502, a clamp circuit 3503, a control circuit 3504, 3-phase AC input terminals 3505, 3-phase AC output terminals 3506, input voltage transducers 3511, isolated DC-to-DC converters 3512, switch drivers 3513, a heat sink 3514, output current transducers 3515, current direction sensors 3516, and a shaft position sensor 3517.

As shown in FIG. 35, the clamp circuit 3503 includes a switched mode power supply 3520 that generates a regulated DC voltage that powers the control circuit 3504 and that serves as an input voltage to the isolated DC-to-DC converters 3512. The isolated DC-to-DC converters 3512 (for instance, flyback converters) output DC voltages that power the switch drivers 3513.

With continuing reference to FIG. 35, the control circuit 3504 is electrically connected to an interface, such as a serial interface or bus. The interface can connect to a network to facilitate remote control over the matrix converter 3500 and motor 3518. Additionally, the control circuit 3504 includes digital processing circuitry 3531 (for instance, a processor and/or FPGA) that digitally processes data, and data converters 3532 that provide analog-to-digital conversion and digital-to-analog conversion operations. For example, the data converters 3532 can serve to provide conversion of signals received from the depicted sensors and transducers.

The control circuit 3504 receives a variety of signals that indicate operating conditions of the matrix converter 3500. For example, in the illustrated embodiment, the control circuit 3504 receives input voltage sensing signals from the input voltage transducers 3511, an overvoltage sensing signal from the clamp circuit 3503 (for example, from a discharge activation circuit of the clamp circuit 3503), a temperature sensing signal from the heat sink 1704, output current sensing signals from the output current transducers 3515, current direction sensing signals from the current direction sensors 3516, and a shaft position sensing signal from the shaft position sensor 3517.

Implementing the matrix converter 3500 with such sensors provides a number of functions, such as over-current trip protection, over-voltage trip protection, thermal trip protection, and/or enhanced control over rotation, torque, and/or speed of the motor 3518.

The matrix converter may be the main system configured on the power plane P, e.g., that is represented as shown in FIG. 36A-36B. FIG. 36A illustrates a diagram of a bi-directional switch, e.g., using IGBT technology for implementing the desired power functionality. FIG. 36B illustrates an example of a bi-directional switch power module for implementing the desired power functionality. (As a person skilled in the art would appreciate, an insulated-gate bipolar transistor (IGBT) is a three-terminal power semiconductor device primarily used as an electronic switch which, as it was developed, came to combine high efficiency and fast switching. For example, Infineon Technologies AG distributed various products using such IGBT technology.) The purpose of having this circuit shown in FIG. 36A is to allow the matrix converter to convert an AC input of fixed voltage and frequency to a desired AC output waveform. Traditionally, in the prior art input AC power would have to be converted to a DC waveform before being synthesized into an AC output. According to some embodiments, the matrix converter may be configured to execute this process in fewer steps and with fewer components. Among the electronic modules, the power quality filter IFC may be configured as a prominent component. In such a case, its function is to reduce the level of electrical noise and harmonic distortions. In some embodiments, this power quality filter component may be attached directly onto the printed circuit board, such as first PCB board 1320 to be as close to the matrix converter as possible. This greatly improves its ability to reduce the amount of distortions emitted from the matrix converter electronics. The overall geometry and size of the power plane P allows for ease of manufacture and installation for power modules and control electronics.

In this power plane portion of the overall motor assembly shown in FIG. 1, heat will be emitted from at least two sources: the power semi-conductor modules and the shaft or rotor 115. Consistent with that set forth herein, the power semi-conductor modules may include one or more of the following: the circular power modules arrangement shown in FIG. 12 or the power modules layout shown in FIG. 25A, power modules and clamp module layout in FIG. 25A or the layout of the power/clamping modules in FIG. 13, among others. Although the mid-plate may be configured with an insulation layer protecting the electronics, as described above, there will likely still be residual heat from the shaft or rotor 115. This is due to the temperature difference between the fan side and the mid-plate portion of the motor assembly. It is also understood that semi-conductors in the power plane will naturally generate heat during operation. The challenge is maintaining an operating temperature in order for the electronics to operate properly, e.g., below the failure point of the electronics.

Therefore, insulation and dissipation of heat are two functions that the power plane can perform. The former regarding insulation may be achieved through the multi-layered circuit board implementation disclosed herein. The multi-layered circuit board may be constructed of laminated material such as fiberglass, by way of example, which increases its thickness and strength. Fiberglass is known and understood to be a strong and light-weight material which has been used for insulation applications. This allows the power plane P to act as a thermal barrier between hotter power modules, the power quality capacitors and control electronics.

For the latter, heat may be dissipated through the heat sink fins, the fan, and/or the liquid cooling system described herein. The heat sink fins can be air cooled and act as cooling mechanisms. They operate through conduction and convection, two forms of heat transfer, where conduction is understood to be the transfer of heat between solids that are in contact with each other, while convection is understood to be the transfer of heat between a solid and a fluid. Heat transfer will first occur between the printed circuit board and the semi-conductors. It will then travel into the end-plate and heat sink fins. Convection occurs between the heat fins and the ambient air, e.g., surrounding the overall motor assembly 100 (FIG. 1) dispersing the heat. To function properly, the fins have to be cooler to absorb heat and be elevated to a hot enough temperature to diffuse it into ambient air. Since the power plane, or the distribution of power modules and/or elements 2504 also shares a similar geometry with the intermediate portion of the end-plate, the heat will be distributed uniformly along the surface.

The overall configuration of this multi-purpose power plane makes it an important contribution to the state of the art. The space envelope or cavity from the end-plate allocates room for the overall power plane and allows it to support both power modules and control electronics. In addition, the power plane has access to the heat sink fins from the end-plate, enabling it to cool the electronics at an operable temperature. The fiberglass circuit board construction of layer) acts as an excellent insulator separating hotter power semiconductors from the sensitive control electronics and power quality capacitors. These combined components allow the power plane to facilitate operating conditions and maintain the temperature of the control electronics well below maximum temperature levels.

### Advantages

Advantages of this power plane embodiment may include one or more of the following:

The printed circuit board layer may be configured to act as a thermal barrier between hotter power modules to the cooler control electronics and power quality capacitors area.

The overall power plane implementation may be configured so as to direct heat to outer diameter where there is a higher air flow and away from control circuits.

The overall printed circuit board assembly provides a low inductance and resistance input between the power quality capacitors and the power semiconductor modules, thereby reducing switching stress and electromagnetic interference.

The overall power plane implementation may be configured with a unique compact power quality filter arrangement that is integrated into the power plane.

The overall power plane implementation may be configured with a built-in power quality filter that produces minimal harmonic distortion, and protects the variable frequency electronics from most power quality abnormalities.

The overall power plane implementation may be configured with or as a unique doughnut shaped power plane printed circuit board (PCB), e.g., shaped like the power layer 800, to fit in the space envelope 600 or cavity of the motor end-plate providing for maximum space utilization, and simplifying construction and manufacturing.

The doughnut shape allows the motor shaft or rotor 115 to pass through to power the cooling fan 145.

The overall power plane implementation combines both power and control modules, circuits or components into one integrated printed circuit board assembly for ease of assembly and compactness in size.

The overall power plane implementation provides interconnections for input/output power, current sensors, gate driver GDPS, clamp control circuit CCCs, power/clamp semi-conductor modules, power quality capacitors IFC, e.g. with limited wiring and connectors required, thus allowing for a robust and reliable operation.

The overall power plane implementation allows for the manufacture of an embedded electronic motor drive in power levels greater than that currently produced in the marketplace and in the space envelope of an electric motor.

The motor frame or casing MF is effectively utilized as a heat sink to allow compact size and thermally optimized operation of the power plane and matrix converter configuration.

### Terminology

It should be understood that, unless stated otherwise herein, any of the features, characteristics, alternatives or modifications described regarding a particular embodiment herein may also be applied, used, or incorporated with any other embodiment described herein. Also, the drawing herein is not drawn to scale.

Although described and illustrated with respect to exemplary embodiments thereof, the foregoing and various other additions and omissions may be made therein and thereto without departing from the spirit and scope.

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be embodied in, and fully automated via, software code modules executed by a computing system that includes one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence, can be added, merged, or left out altogether (for example, not all described acts or events are necessary for the practice of the algorithms). Moreover, in certain embodiments, acts or events can be performed concurrently, for example, through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiments disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of computing devices, for example, a combination of a DSP and a microprocessor, a plurality of microprocessors, one or more microprocessors in conjunction with a DSP core, or any other such configuration. Although described herein primarily with respect to digital technology, a processor may also include primarily analog components. A computing environment can include any type of computer system, including, but not limited to, a computer system based on a microprocessor, a mainframe computer, a digital signal processor, a portable computing device, a device controller, or a computational engine within an appliance, to name a few.

Conditional language such as, among others, “can,” “could,” “might” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is otherwise understood with the context as used in general to present that an item, term, etc., may be either X, Y, or Z, or any combination thereof (for example, X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

It should be emphasized that many variations and modifications may be made to the above-described embodiments, the elements of which are to be understood as being among other acceptable examples. All such modifications and variations are intended to be included herein within the scope of this disclosure.

What is claimed is:

1. A motor assembly comprising:
a motor housing;
an electrical motor at least partially disposed in the motor housing;
a mid-plate disposed in-line with the motor housing, the mid-plate having a first mid-plate wall distal to the motor housing;
an end-plate disposed in-line with the mid-plate such that the mid-plate is between the motor housing and the end-plate, the end-plate having an interior wall and an exterior wall, wherein a gap exists between the interior wall and the exterior wall, and wherein the interior wall forms a cavity; and
a variable frequency drive electronics unit disposed within the cavity and configured to provide power to the electrical motor, wherein the variable frequency drive electronics unit comprises a plurality of power modules distributed along the interior wall of the cavity.

2. The motor assembly of claim 1, further comprising a thermal conductor positioned at an entrance to the cavity.

3. The motor assembly of claim 1, wherein the cavity is sealed to prevent or reduce an occurrence of dust within the cavity.

4. The motor assembly of claim 1, wherein the exterior wall of the end-plate comprises an ingress hole and an egress hole, and wherein the ingress hole and the egress hole do not extend through the interior wall of the end-plate.

5. The motor assembly of claim 4, wherein the ingress hole is located on a back wall of the end-plate, and wherein the back wall faces a fan configured to cause air to flow along the back wall and into the ingress hole.

6. The motor assembly of claim 4, wherein the egress hole is located on a peripheral wall of the end-plate, and wherein an air flow generated by a fan causes air to flow into the ingress hole and out of the egress hole.

7. The motor assembly of claim 4, further comprising:
a pipe positioned to enter the ingress hole and to exit the egress hole; and
a coolant system configured to distribute a liquid coolant through the pipe.

8. The motor assembly of claim 7, wherein the pipe is further positioned to contact a portion of the interior wall that is in contact with the plurality of power modules.

9. The motor assembly of claim 7, wherein the pipe comprises an ingress pipe and an egress pipe, wherein the egress pipe is configured to transport the liquid coolant from the coolant system through the gap between the interior wall and the exterior wall, and wherein the ingress pipe is configured to transport the liquid coolant back towards the coolant system.

10. The motor assembly of claim 7, wherein the coolant system comprises a pump that pumps the liquid coolant through the pipe.

11. The motor assembly of claim 7, wherein the coolant system comprises a reservoir to at least temporarily store the liquid coolant.

12. The motor assembly of claim 7, further comprising a fan configured to cause air to flow along the coolant system to cool the liquid coolant.

13. The motor assembly of claim 1, wherein the end-plate further comprises an opening to receive a non-drive end of a rotor, and wherein the non-drive end of the rotor is configured to rotate a fan to cause air to flow along the exterior wall of the end-plate.

14. A variable frequency motor drive comprising:
a plate configured to directly or indirectly mount to an electrical motor, the plate having an interior wall and an exterior wall, wherein a gap exists between the interior wall and the exterior wall, and wherein the interior wall forms a cavity; and
a variable frequency drive electronics unit disposed within the cavity and configured to provide power to the electrical motor, wherein the variable frequency drive electronics unit comprises a plurality of power modules distributed along the interior wall of the cavity.

15. The variable frequency motor drive of claim 14, further comprising a thermal conductor positioned at an entrance to the cavity.

16. The variable frequency motor drive of claim 14, wherein the cavity is sealed to prevent or reduce an occurrence of contaminants within the cavity.

17. The variable frequency motor drive of claim 14, wherein the exterior wall of the plate comprises an ingress hole and an egress hole, and wherein the ingress hole and the egress hole do not extend through the interior wall of the plate.

18. The variable frequency motor drive of claim 17, wherein the ingress hole is located on a back wall of the plate and the egress hole is located on a peripheral wall of the plate, and wherein the back wall faces a fan configured to cause air to flow into the ingress hole and through to the egress hole.

19. The variable frequency motor drive of claim 17, further comprising:
a pipe positioned to enter the ingress hole and to exit the egress hole; and
a coolant system configured to distribute a liquid coolant through the pipe, wherein the coolant system comprises a pump that pumps the liquid coolant through the pipe, and wherein the coolant system comprises a reservoir to at least temporarily store the liquid coolant.

20. The variable frequency motor drive of claim 19, wherein the pipe is further positioned to contact a portion of the interior wall that is in contact with the plurality of power modules.

21. The variable frequency motor drive of claim 19, wherein the pipe comprises an ingress pipe and an egress pipe, wherein the egress pipe is configured to transport the liquid coolant from the coolant system through the gap between the interior wall and the exterior wall, and wherein the ingress pipe is configured to transport the liquid coolant back towards the coolant system.

22. The variable frequency motor drive of claim 19, further comprising a fan configured to cause air to flow along the coolant system to cool the liquid coolant.

23. The variable frequency motor drive of claim 14, wherein the plate further comprises an opening to receive a non-drive end of a rotor, and wherein the non-drive end of the rotor is configured to rotate a fan to cause air to flow along the exterior wall of the plate.
